(19) United States
(12) Patent Application Publication
(10) Pub. No.: US 2006/0196814 A1
(43) Pub. Date: Sep. 7, 2006

(54) Method and apparatus for processing particulate material

(76) Inventor: Andrew Vince, Mackay QLD (AU)

Correspondence Address: BRINKS HOFER GILSON & LIONE, P.O. BOX 10395, CHICAGO, IL, 60610, US

(21) Appl. No.: 10/541,483

(22) PCT Filed: Dec. 24, 2003
(86) PCT No.: PCT/AU03/01727

§ 371 Date: Mar. 31, 2006

(30) Foreign Application Priority Data
Jan. 10, 2003 (AU) 2003900089

(51) Int. Cl. B01D 35/00

(52) U.S. Cl. 210/85

(57) ABSTRACT

A method and apparatus for processing particulate material such as coal, and also for measuring the efficiency of separation of the coal is disclosed. Particulate material is supplied to a separator such as a heavy medium device containing a dense medium (6). A parameter of the device (6) indicative of separation cut point is measured. The parameter may be density of the medium, flow rate of material or pressure of feed as well as medium to coal ratio. Measurements of these parameters are made over a time period and, from the measurements, an induced value indicative of separating efficiency is determined. The induced value provides a measure of separation efficiency and also provides a value which can be compared with a predetermined value so that an alarm can be generated if the value departs from the predetermined value by a predetermined amount.

### FIELD OF THE INVENTION

This invention relates to a method and apparatus for processing particulate material and, in particular, minerals and carbonaceous solids such as coal, iron ore, manganese, diamonds and other materials. The invention has particular application to the processing of coal, and will be further described in relation to the processing of coal. However, it should be understood that the invention is applicable to processing other materials including but not restricted to those mentioned above.

### BACKGROUND OF THE INVENTION

Raw coal is mined from the ground and is processed to provide a desirable commercial product. Raw coal includes a certain amount of gangue mineral content which, following combustion under standard conditions, leaves a solid ash residue.

For some applications (eg coke making) saleable coal most preferably has a fixed ash specification limit which is normally specified in contractual agreements between the producer and the purchaser. A typical example of an ash specification for high quality coking coal is 10% (air dried basis). If the ash level of produced coal increases above this level, the product may still be saleable but its price is deleteriously affected and/or some penalties for the producer may be incurred.

For other applications, saleable coal most preferably has a minimum or fixed specific energy content limit which is normally specified in contractual agreements between the producer and the purchaser. A typical example of an energy specification for high quality thermal coal is 6000 kCal/kg (net as received basis). If the specific energy level of produced coal decreases below this level, the product may still be saleable but its price is deleteriously affected and/or some penalties for the producer may be incurred.

Raw coal after mining may be comminuted to a required size and separated into a particular particle size by a screen mesh type or other classification-type device to separate the raw coal into predetermined particle sizes defined by, for example, the screen aperture size of the screen separator and other operating characteristics such as state of screen wear, solids loading level, water addition rate etc.

The separated coal of the desired size is then supplied to a dense medium separator. There are a number of different dense medium separators currently in use depending on the size of particles being treated. For example, large lumps may be processed in heavy medium drums, heavy medium baths, heavy medium vessels, larcodems etc, and smaller but still coarse particles may be processed in heavy medium cyclones, heavy medium cycloids etc. Note that the words “heavy” and “dense” can be used interchangeably in this context. These types of heavy medium devices use a benign or inert finely ground powder of medium solids (such as magnetite or ferro-silicon) slurried in water to form a dense medium whose density can be automatically controlled by the proportion of solids in the slurry. Mixing the raw coal with the dense medium enables separation on the basis of its density relative to the density of the dense medium. For example, coal with an ash level of 10% may be separable from higher ash components of the raw coal by adding the raw coal to a dense medium of, for example, 1400 kg/m³. In this example, the 10% ash product coal might float clear of the higher ash material which might tend to sink in the dense medium. The material that floats would report to the overflow outlet of a separator and that which sinks would report to the underflow outlet.

For the specific case of a dense medium cyclone, it is separating efficiency of the coal particles that is often critical to maximising yield and recovery. The accepted industry standard for measuring efficiency is the partition coefficient curve with its characteristic D₅₀ and Ep parameters. The D₅₀ is the separating density of the particles and the Ep is a measure of the sharpness the separation (a higher value of Ep indicates more misplacement of particles and hence a lower efficiency).

Whilst the D₅₀ of a separation is strongly related to the medium density, there are machine effects that lead to, almost invariably, the D₅₀ being a little higher than the medium density. The difference between D₅₀ and the medium is conventionally termed “offset”. The extent to which it is greater is dependent on a number of parameters, including, but not limited to, medium density, dense medium cyclone pressure, raw coal feed rate, medium to coal ratio, and variations therein. The overall sharpness of separation is a strong function of variations in each of these parameters (medium density, pressure, feed rate and medium to coal ratio).

Measurement of the density of medium slurry is performed by, for example, nucleonic gauges or differential pressure transducers. Measurement of pressure of the material feeding a dense medium cyclone is performed with pressure transducers and the like, while plant feed rate is determined with weightometers on the conveyor belt feeding the plant. Medium to coal ratio is not conventionally measured on-line and plant feed rate may be used as a proxy. However, it is conceivable that such measurement may be made in the future when the measurement technology is developed.

Each of these parameters may be incorporated into individual control systems which attempt to maintain operational values of these parameters within acceptable limits. However, control systems are imperfect and variations occur during normal industrial operations. Variations in the medium density, pressure, feed rate and medium to coal ratio cause separations to occur at densities (D₅₀'s) different from those desired. Momentary fluctuations that lead to higher D₅₀'s than desired will result in higher proportions of the raw coal being collected at the separator floats or overflow outlet. A momentary change in product quality will occur with a higher ash material separated. Similarly, the momentary changes in product quality will occur when fluctuations lead to lower D_{50's}, which result in decreases in the ash of the separated material.

Whilst plant control systems almost invariably allow overall consignment product within ash specification to be separated, this is often achieved at the expense of yield and recovery. Maximum yield or recovery at a given product quality is achieved when fluctuations in each of medium density, pressure,feed rate and medium to coal ratio are minimised.

Typically, in order to obtain an Ep value, samples of the material which are being processed (such as coal) are acquired representatively following strict sampling procedures. This typically involves concurrent taking of a sample from the feed line to the separator, and also samples which have reported to product and reported to reject. Those three samples are then forwarded to a laboratory for analysis and raw data is obtained which is then analysed to produce the partition curve. Typically, the taking of the samples involves a number of people who may, for example, take sample increments over a nine hour period. Furthermore, typically the analysis of the samples and then the preparation of the partition curve may take several weeks. Thus, results are not available in accordance with the prior art teaching for some weeks or the like after the sample material is actually acquired.

### SUMMARY OF THE INVENTION

The object of the invention is to provide a method and apparatus for processing particulate material, such as coal, in which yield or recovery losses can be reduced.

The present invention provides a method of processing particulate material, including the steps of:

supplying the particulate material to a separator;

monitoring a parameter or parameters of the separator indicative of a separation value of the material;

determining from said parameter an induced value indicative of the separating efficiency of the material that passed through said separator;

comparing said value with a predetermined value; and

generating an alarm condition if the said value departs from the predetermined value by a predetermined amount.

Thus, according to the invention, if the effective separating efficiency departs from the required separating efficiency by a predetermined amount an alarm signal is generated. This enables remedial action to be taken to correct whatever fault has caused the change in the separating efficiency of the dense medium device, thereby returning the separating efficiency to its desired level to decrease the loss due to fluctuations in the separating density of the material. In other words, the fluctuation cycle of the cut point and other partition coefficient-based characteristics can be more quickly responded to so as to reduce both the magnitude and time of the fluctuations to reduce yield and recovery losses caused by those fluctuations.

The separation value may comprise the separating density if the separator is a medium dense separator or may be size of material if the separator is a classifying separator based on size of the material.

Preferably the separator comprises a heavy medium device containing a dense medium.

Preferably the step of determining the induced value comprises determining an induced set of values indicative of the separating efficiency of the material that passed through the device, the step of comparing said value comprises comparing said set of values with a predetermined range for the set of values, and the step of generating the alarm condition comprises generating the alarm condition if the said set of values departs from the predetermined range for the set of values by a predetermined amount.

The set of values may be in the form of a partition coefficient curve and parameters derived therefrom.

In the preferred embodiment of the invention, the parameter which is monitored is the actual density of the medium.

However, in another embodiment, the parameter is pressure of the medium and particle mixture which is supplied to the device.

In a still further embodiment the parameter is the feed rate of the medium and particle mixture supplied to the device. A practical proxy for this is the overall processing plant feed rate.

In a still further embodiment the parameter is the ratio of volume or mass flow rate of medium to the volume or mass flow rate of the raw coal, commonly referred to as “Medium to Coal Ratio”. Direct measurement of this parameter is preferable, but a practical proxy is processing plant feed rate.

In a still further embodiment of the invention, two or more of the medium density, pressure of the medium and particle mixture, feed rate of the medium and particle mixture, and Medium to Coal Ratio are monitored.

In the preferred embodiment of the invention, the density of the medium is measured at predetermined time intervals, and for a predetermined time period, the number of measurements at each measured value is determined to produce a cumulative normalised frequency distribution of the length of time the particle spends at each measured density, and said set of values characterising separating efficiency is determined as a medium induced partition coefficient curve and/or a parameter derived therefrom, for example medium induced Ep value (MIEp value) by taking the absolute value of the difference in density at the 75^{th} and 25^{th} percentiles, and dividing by 2000 so as to produce an MIEp value which is a theoretical value solely dependent on medium density variations, and comparing the MIEP value with the said predetermined value, or medium induced partition coefficient curve with a predetermined partition coefficient curve. When making the necessary measurements to calculate the said separating efficiency characteristics, the predetermined time interval should be small in relation to the predetermined time period. A further assumption implicit in this approach is that offset is constant over the range of density values encountered.

In the other embodiments of the invention a feed rate induced partition coefficient curve and/or a parameter derived therefrom, for example feed rate induced Ep(FRIEp) value is determined in the same manner from the feed rate measurements made over the predetermined time period.

However a theoretical and/or empirical calibration will be required to convert feed rate variation to D₅₀ variation so as to produce a cumulative normalised frequency distribution of separating densities and so provide the length of time spent at each separating density. However, a pseudo-feed rate induced partition coefficient curve and derivatives therefrom may be calculated without the need for a theoretical and/or empirical calibration. In such case the cumulative normalised frequency distribution curve would be plotted against feed rate as the abscissa and a pseudo FRIEp calculated in a similar manner to MIEp. As the pseudo variation on the concept does not require calibration, is easier to measure and use, and it is the preferred method of efficiency assessment if the parameter is feed rate. In the case of measuring the pressure of the medium and particle mixture, a pressure induced partition coefficient curve and a derived pressure induced Ep(PIEp) value is determined so that individual values over the predetermined time period are used to calculate a cumulative normalised frequency distribution of separating densities, giving the length of time spent at each separating density. Once again a theoretical and/or empirical calibration is required to convert pressure measurements to separating density (D₅₀) In a similar manner to the case for feed rate, a pseudo curve and pseudo PIEp may be calculated. As the pseudo variation on the concept does not require calibration, is easier to measure and use, and it is the preferred method of efficiency assessment if the parameter is pressure. In the case of measuring the Medium to Coal Ratio of the medium and particle mixture, a Medium to Coal Ratio induced partition coefficient curve and a derived Medium to Coal Ratio induced Ep(MCRIEp) value is determined so that individual values over the predetermined time period are used to calculate a cumulative normalised frequency distribution of separating densities, giving the length of time spent at each separating density. Once again a theoretical and/or empirical calibration is required to convert Medium to Coal Ratio measurements to separating density (D₅₀). In a similar manner to the case for feed rate and pressure, a pseudo curve and pseudo MCRIEp may be calculated. As the pseudo variation on the concept does not require calibration, is easier to measure and use, and it is the preferred method of efficiency assessment if the parameter is medium to coal ratio.

The present invention may be said to reside in an apparatus for processing particulate material, comprising:

means for supplying the particulate material to a separator;

means for monitoring a parameter of the separator indicative of a separation value of the material;

processing means for determining from said parameter an induced value indicative of the separating efficiency of the material that passed through said separator;

comparing means for comparing said value with a predetermined value; and

alarm means for producing an alarm condition if the said value departs from the predetermined value set by a predetermined amount.

Preferably the separator comprises a heavy medium device.

Preferably the processing means determines from said parameter an induced set of values indicative of the separating efficiency of the material that passed through the device, the comparing means compares the said value set with a predetermined value set and the alarm means is for producing the alarm condition if the set of values departs from the predetermined value set by a predetermined amount.

The set of values may be in the form of an induced partition coefficient curve and parameters derived therefrom.

In the preferred embodiment of the invention, the monitoring means measures the density of the medium at predetermined time intervals, and for a predetermined time period, such that the predetermined time intervals are small compared to the predetermined time and the processing means determines the number of measurements at each measured value to produce a cumulative normalised frequency distribution of the length of time the particle spends at each measured density, and determines said value set as a medium induced partition coefficient curve and/or parameters derived therefrom, for example medium induced Ep value (MIEp value) by taking the absolute value of the difference in relative density at the 75^{th} and 25^{th} percentiles, and dividing by 2000 so as to produce an MIEp value which is a theoretical value solely dependent on medium density variations, and comparing the partition coefficient curve and parameters derived therefrom, for example, MIEp value set with the said predetermined value set.

In the other embodiments of the invention a feed rate induced partition coefficient curve and parameters derived therefrom, for example Ep(FRIEp) value set is determined in a similar manner from the feed rate measurements made over the predetermined time period. As feed rate to dense medium separators is not commonly measured directly, overall processing plant feed rate is used as a proxy. However a theoretical and/or empirical calibration will be required to convert feed rate variation to D₅₀ variation so as to produce a cumulative normalised frequency distribution of separating densities and so provide the length of time spent at each separating density. However, a pseudo-feed rate induced partition coefficient curve and derivatives there from may be calculated without the need for a theoretical and/or empirical calibration. In such case the cumulative normalised frequency distribution curve would be plotted against feed rate as the abscissa and a pseudo FRIEp calculated in a similar manner to MIEp. As the pseudo variation on the concept does not require calibration, is easier to measure and use, and it is the preferred method of efficiency assessment. In the case of measuring the pressure of the medium and particle mixture, a pressure induced partition coefficient curve and parameters derived therefrom, for example, pressure induced Ep(PIEP) value set is determined in a similar manner from the pressure measurements made over the predetermined time period. However a theoretical and/or empirical calibration will be required to convert pressure variation to D₅₀ variation so as to produce a cumulative normalised frequency distribution of separating densities and so provide the length of time spent at each separating density. In a similar manner to the case for feed rate, a pseudo curve and pseudo PIEp may be calculated. As the pseudo variation on the concept does not require calibration, is easier to measure and use, and it is the preferred method of efficiency assessment. In the case of measuring the Medium to Coal Ratio, a Medium to Coal Ratio induced partition coefficient curve and parameters derived therefrom, for example, Medium to Coal Ratio induced Ep(MCRIEp) value set is determined in a similar manner from the Medium to Coal Ratio measurements made over the predetermined time period. However a theoretical and/or empirical calibration will be required to convert Medium to Coal Ratio variation to D₅₀ variation so as to produce a cumulative normalised frequency distribution of separating densities and so provide the length of time spent at each separating density. In a similar manner to the case for feed rate and pressure, a pseudo curve and pseudo MCRIEp may be calculated. As the pseudo variation on the concept does not require calibration, is easier to measure and use, and it is the preferred method of efficiency assessment.

A second aspect of the invention provides a method of determining the efficiency of separation of particulate material supplied to a separator, comprising the steps of:

monitoring a parameter of the separator indicative of a separation value of the material;

determining from said parameter an induced value indicative of the separating efficiency of the material that pass through the separator; and

using the induced value to provide a measure of the efficiency of separation.

Thus, according to this aspect of the invention, because a parameter of the separator, rather than the material which is being separated is monitored, the data required to determine efficiency can be acquired much more quickly and also much less expensively because the equipment needed to measure the parameters of the separator, rather than analysis actual sample material can be performed much quicker and less expensively. In addition, in the case of medium induced Ep, the density measurements required are readily available as they comprise those used to as part of a density control system. The same can be said for pressure and feed rate. Thus, an efficiency measure of the separation of the coal can be produced almost in real time, thereby enabling remedial action to be taken should the efficiency of separation deteriorate. This in turn enables a processing plant for processing the material to be corrected where necessary to ensure that separation is efficiently performed, thereby producing better product and economic results.

Preferably the step of determining the induced value comprises determining an induced set of values indicative of the separating efficiency of the material that passed through the device, the step of comparing said value comprises comparing said set of values with a predetermined range for the set of values, and the step of generating the alarm condition comprises generating the alarm condition if the said set of values departs from the predetermined range for the set of values by a predetermined amount.

The set of values may be in the form of an induced partition coefficient curve and parameters derived therefrom.

In the preferred embodiment of the invention, the parameter which is monitored is the actual density of the medium.

However, in another embodiment, the parameter is pressure of the medium and particle mixture which is supplied to the device.

In a still further embodiment the parameter is the feed rate of the medium and particle mixture supplied to the device. A practical proxy for this is the overall processing plant feed rate.

In a still further embodiment the parameter is the ratio of volume or mass flow rate of medium to the volume of mass flow rate of the raw coal, commonly referred to as “Medium to Coal Ratio”. Direct measurement of this parameter is preferable, but a practical proxy is processing plant feed rate.

In a still further embodiment of the invention, two or more of the medium density, pressure of the medium and particle mixture, feed rate of the medium and particle mixture, and Medium to Coal Ratio are monitored.

In the preferred embodiment of the invention, the density of the medium is measured at predetermined time intervals, and for a predetermined time period, the number of measurements at each measured value is determined to produce a cumulative normalised frequency distribution of the length of time the particle spends at each measured density, and said set of values characterising separating efficiency is determined as a medium induced partition coefficient curve and/or a parameter derived therefrom, for example medium induced Ep value (MIEp value) by taking the absolute value of the difference in density at the 75^{th} and 25^{th} percentiles, and dividing by 2000 so as to produce an MIEp value which is a theoretical value solely dependent on medium density variations, and comparing the MIEp value with the said predetermined value, or medium induced partition coefficient curve with a predetermined partition coefficient curve. When making the necessary measurements to calculate the said separating efficiency characteristics, the predetermined time interval should be small in relation to the predetermined time period. A further assumption implicit in this approach is that offset is constant over the range of density values encountered.

In the other embodiments of the invention a feed rate induced partition coefficient curve and/or a parameter derived therefrom, for example feed rate induced Ep(FRIEp) value is determined in the same manner from the feed rate measurements made over the predetermined time period. However a theoretical and/or empirical calibration will be required to convert feed rate variation to D₅₀ variation so as to produce a cumulative normalised frequency distribution of separating densities and so provide the length of time spent at each separating density. However, a pseudo feed rate induced partition coefficient curve may be derived without the need for a theoretical and/or empirical calibration. In such case the cumulative normalised frequency distribution curve would be plotted against feed rate as abscissa and the pseudo FRIEP calculated in a similar way to FRIEP. As the pseudo variation on the concept does not require calibration, is easier to measure and use, and it is the preferred method of efficiency assessment. In the case of measuring the pressure of the medium and particle mixture, a pressure induced partition coefficient curve and a derived pressure induced Ep(PIEp) value is determined so that individual values over the predetermined time period are used to calculate a cumulative normalised frequency distribution of separating densities, giving the length of time spent at each separating density. Once again a theoretical and/or empirical calibration is required to convert pressure measurements to separating density (D₅₀) However, a pseudo pressure induced partition coefficient curve may be derived without the need for a theoretical and/or empirical calibration. In such case the cumulative normalised frequency distribution curve would be plotted against feed rate as abscissa and the pseudo PIEp calculated in a similar way to PIEp. As the pseudo variation on the concept does not require calibration, is easier to measure and use, and it is the preferred method of efficiency assessment. In the case of measuring the Medium to Coal Ratio of the medium and particle mixture, a Medium to Coal Ratio induced partition coefficient curve and a derived Medium to Coal Ratio induced Ep(MCRIEp) value is determined so that individual values over the predetermined time period are used to calculate a cumulative normalised frequency distribution of separating densities, giving the length of time spent at each separating density. Once again a theoretical and/or empirical calibration is required to convert Medium to Coal Ratio measurements to separating density (D₅₀) However, a pseudo Medium to Coal Ratio induced partition coefficient curve may be derived without the need for a theoretical and/or empirical calibration. In such case the cumulative normalised frequency distribution curve would be plotted against feed rate as abscissa and the pseudo MCRIEP calculated in a similar way to MCRIEp. As the pseudo variation on the concept does not require calibration, is easier to measure and use, and it is the preferred method of efficiency assessment.

This aspect of the invention also provides using the measure of efficiency determined according to the above method to adjust a processing plant to more efficiently separate the material.

This aspect of the invention also provides an apparatus for processing particulate material, comprising:

means for supplying the particulate material to a separator;

means for monitoring a parameter of the separator indicative of a separation value of the material; and

processing means for determining from said parameter an induced value indicative of the separating efficiency of the material that pass through said separator to thereby provide a measure of the efficiency of the apparatus.

Preferably the separator comprises a heavy medium device. Preferably the processing means determines from said parameter an induced set of values indicative of the separating efficiency of the material that passed through the device, the comparing means compares the said value set with a predetermined value set and the alarm means is for producing the alarm condition if the set of values departs from the predetermined value set by a predetermined amount.

The set of values may be in the form of a partition coefficient curve and parameters derived therefrom.

In the preferred embodiment of the invention, the monitoring means measures the density of the medium at predetermined time intervals, and for a predetermined time period, and the processing means determines the number of measurements at each measured value to produce a cumulative normalised frequency distribution of the length of time the particle spends at each measured density, and determines said value set as a medium induced partition coefficient curve and/or parameters derived therefrom, for example medium induced Ep value (MIEp value) by taking the absolute value of the difference in relative density at the 75^{th} and 25^{th} percentiles, and dividing by 2000 so as to produce an MIEp value which is a theoretical value solely dependent on medium density variations, and comparing the partition coefficient curve and parameters derived therefrom, for example, MIEp value set with the said predetermined value set.

In the other embodiments of the invention a feed rate induced partition coefficient curve and parameters derived therefrom, for example Ep(FRIEp) value set is determined in a similar manner from the feed rate measurements made over the predetermined time period. As feed rate to dense medium separators is not commonly measured directly, overall processing plant feed rate is used as a proxy. However a theoretical and/or empirical calibration will be required to convert feed rate variation to D₅₀ variation so as to produce a cumulative normalised frequency distribution of separating densities and so provide the length of time spent at each separating density. However, a pseudo-feed rate induced partition coefficient curve and derivatives there from may be calculated without the need for a theoretical and/or empirical calibration. As the pseudo variation on the concept does not require calibration, is easier to measure and use, and it is the preferred method of efficiency assessment. In the case of measuring the pressure of the medium and particle mixture, a pressure induced partition coefficient curve and parameters derived therefrom, for example, pressure induced Ep(PIEp) value set is determined in a similar manner from the pressure measurements made over the predetermined time period. However a theoretical and/or empirical calibration will be required to convert pressure variation to D₅₀ variation so as to produce a cumulative normalised frequency distribution of separating densities and so provide the length of time spent at each separating density. In a similar manner to the case for feed rate, a pseudo curve and pseudo PIEp may be calculated. As the pseudo variation on the concept does not require calibration, is easier to measure and use, and it is the preferred method of efficiency assessment. In the case of measuring the Medium to Coal Ratio, a Medium to Coal Ratio induced partition coefficient curve and parameters derived therefrom, for example, Medium to Coal. Ratio induced Ep(MCRIEp) value set is determined in a similar manner from the Medium to Coal Ratio measurements made over the predetermined time period. However a theoretical and/or empirical calibration will be required to convert Medium to Coal Ratio variation to D₅₀ variation so as to produce a cumulative normalised frequency distribution of separating densities and so provide the length of time spent at each separating density. In a similar manner to the case for feed rate and pressure, a pseudo MCRIEP may be calculated. As the pseudo variation on the concept does not require calibration, is easier to measure and use, and it is the preferred method of efficiency assessment.

Conventionally, the partition coefficient curve is measured by determining how coal particles entering the separating device separate. This invention separates the impact of separator design, operational configuration and wear condition from the impact of processing operating variables such as medium density, pressure and flow rates. In essence, the invention separates in to distinct measurable entities inefficiencies due to variations in process variables such as medium density, pressure and flow rates. The overall separating Ep for coal will be the combination of the Ep due to the separator design, configuration and wear condition (which has a relatively slow temporal change rate), Ep due to medium density variation, Ep due to pressure variation, Ep due to feed rate variation etc. The later factors will have a much higher temporal change rate. Furthermore, whilst conventional measurement of coal partition coefficient curve is laborious and time consuming, quantification of the process variables, particularly medium density, pressure and feed rate is rapid, easy and cheap to achieve on-line utilising systems and equipment commonly existing in modern processing facilities.

### BRIEF DESCRIPTION OF THE DRAWINGS

A preferred embodiment of the invention will be described, by way of example, with reference to the accompanying drawings in which:

FIG. 1 is an illustrative diagram illustrating apparatus for processing coal;

FIG. 2 is a block diagram illustrating the operation of the preferred embodiment of the invention;

FIG. 3 is a graph showing the accumulative normalised frequency distribution for an ideal situation; and

FIG. 4 is a graph of the type of FIG. 3 exemplifying what may occur in actual practice.

### DETAILED DESCRIPTION OF THE PREFERRED EMBODIMENTS

The following is a specific example of a generic dense medium cyclone circuit. It is given as a means only of explaining how the invention can be applied and does not limit the coverage of the invention to the specific example given.

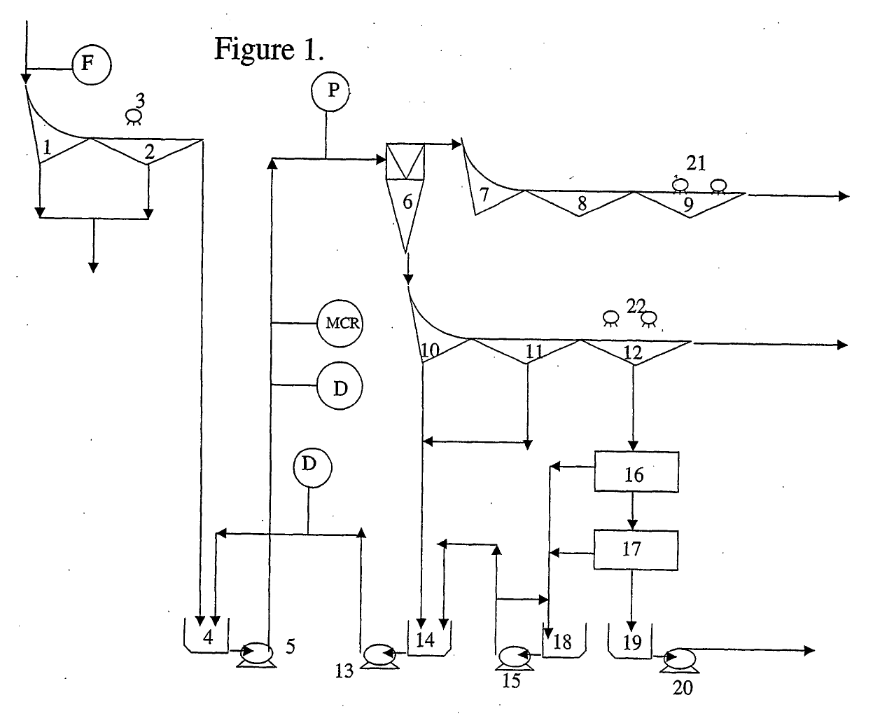

Prior to entering the process depicted in FIG. 1, raw coal may be reduced to 50 mm top size. With reference to FIG. 1, raw coal is separated on a sieve bend 1 followed by a vibratory screen 2 with wash water addition 3. This device removes fine particles, typically less than 2-0.2 mm, from the raw coal and all the undersize is processed in devices not mentioned here. The oversize material gravitates to sump 4 from which it is pumped 5 to the dense medium cyclone 6. It will be noted on FIG. 1 that dense medium is added to the coarse coal particles in the dense medium cyclone feed sump 4. The coarse raw coal is separated in the dense medium cyclone 6 to produce a lower ash product and a higher ash reject. The product is separated from the dense medium on sieve bend 7 and drain 8 and rinse screen 9. The sieve bend and drain screens remove the bulk of the dense medium which can then recycled to the dense medium sump 14. The rinse screen 9 uses water addition 21, 22 (dirty and clarified) to aid the removal of medium adhering to the coal particles. Rinse screen underflow is significantly diluted and must be concentrated such that the water is removed before it can be reused in the operation of the dense medium cyclone. Similar sieve bend 10, drain 11 and rinse 12 screen recovery of dense medium occurs for the dense medium cyclone underflow material.

The diluted dense medium is dewatered with magnetic separators 16 and 17. The recovered dense medium is passed to the over-dense sump 18 from where it is pumped 15 to the dense medium sump 14. The separated water is recycled for use elsewhere in the plant, including water addition to the screening operations described above.

Also shown on FIG. 1 are the locations of measuring devices for medium density D, pressure P, Medium to Coal Ratio (MCR) and feed rate F.

It should be noted once again that this is a very brief and simplified description of the generic circuitry for coal processing.

The density of the dense medium supplied to the mixture with the particulate material is measured with a nucleonic or differential pressure transducer D. Two indicative locations for measuring this parameter are indicated on FIG. 1.

The pressure of the medium density and particulate mixture supplied to the dense medium cyclone is also measured by pressure transducer P.

The location of Medium to Coal Ratio measurement is also shown and could be measured by the emerging electro-impedance spectrometry technology which is not yet common place in the industry.

In the preferred embodiment of the invention, the density measurements made by the nucleonic or differential pressure transducer D are used to generate an alarm condition, should the medium induced partition coefficient curve and/or parameters derived therefrom change from the desired values so that remedial action can be taken to restore the desired density control and thereby minimise losses caused by fluctuations or variations in the density of the medium density. However, as has been previously described, the pressure measurements, Medium to Coal Ratio measurements or feed rate measurements may be used in combination with the density measurements or instead of the density measurements in order to continually monitor the fluctuations in medium induced partition coefficient curve and/or parameters derived therefrom to enable the alarm condition to be generated and remedial action immediately taken to restore the required level of control of the dense medium separation.

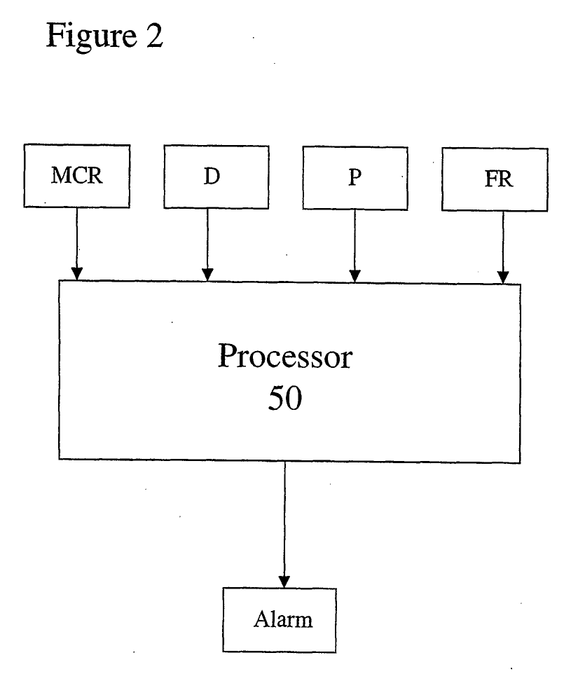

With reference to FIG. 2, the density measurements from the nucleonic or differential pressure transducer D are fed to a processor 50, typically maintained in, but not limited to, the coal plant operation room when in the desired location, or any other suitable location. The pressure and feed rate measurements from the pressure transducer P and weightometers F are also fed to the processor 50. Medium to Coal Ratio measurements from electro-impedance spectrometry technology would also be fed to the processor 50.

According to the preferred embodiment of the invention, measurements are read frequently, for example every 1 minute, and those measurements are taken over a predetermined time period of, for example 30 minutes to 2.5 hours, may be used to determine the value set for comparison with the predetermined value set in order to determine whether the alarm condition needs to be generated.

Table 1 below shows exemplary measurements which may be taken over a time period of 9 hours and used for processing in the processor 50.

TABLE 1

| Time | Density |
|---|---|
| 7:21:54 | 1571.48 |
| 7:22:29 | 1571.29 |
| 7:23:05 | 1568.14 |
| 7:23:41 | 1565.46 |
| 7:24:17 | 1560.24 |
| 7:24:53 | 1557.2 |
| 7:25:29 | 1557.36 |
| 7:26:05 | 1555.98 |
| 7:26:41 | 1552.94 |
| 7:27:17 | 1541.99 |
| 7:27:53 | 1535.55 |
| 7:28:29 | 1530.52 |
| 7:29:05 | 1524.52 |
| 7:29:41 | 1518.36 |
| 7:30:17 | 1508.26 |
| 7:30:53 | 1509.17 |
| 7:31:29 | 1524.88 |
| 7:32:05 | 1550.78 |
| 7:32:41 | 1563.68 |
| 7:33:17 | 1565.84 |
| 7:33:53 | 1563.41 |
| 7:34:29 | 1555.61 |
| 7:35:05 | 1552.5 |
| 7:35:41 | 1544.18 |
| 7:36:17 | 1539.94 |
| 7:36:53 | 1532.69 |
| 7:37:28 | 1526.97 |
| 7:38:04 | 1521.66 |
| 7:38:40 | 1519.88 |
| 7:39:16 | 1516.89 |
| 7:39:52 | 1501.46 |
| 7:40:28 | 1480.52 |
| 7:41:04 | 1471.89 |
| 7:41:40 | 1473.86 |
| 7:42:16 | 1490.65 |
| 7:42:52 | 1511.69 |
| 7:43:28 | 1524.97 |
| 7:44:04 | 1548.59 |
| 7:44:40 | 1580.46 |
| 7:45:16 | 1595.15 |
| 7:45:52 | 1611.78 |
| 7:46:28 | 1618.13 |
| 7:47:04 | 1622.66 |
| 7:47:40 | 1622.54 |
| 7:48:16 | 1618.63 |
| 7:48:52 | 1587.34 |
| 7:49:28 | 1577.82 |
| 7:50:04 | 1568.54 |
| 7:50:40 | 1562.07 |
| 7:51:16 | 1554.97 |
| 7:51:52 | 1549.87 |
| 7:52:27 | 1544.62 |
| 7:53:03 | 1537.75 |
| 7:53:39 | 1526.34 |
| 7:54:15 | 1522.88 |
| 7:54:51 | 1521.17 |
| 7:55:27 | 1522.5 |
| 7:56:03 | 1521.06 |
| 7:56:39 | 1523.56 |
| 7:57:15 | 1524.7 |
| 7:57:51 | 1526.32 |
| 7:58:27 | 1525.81 |
| 7:59:03 | 1524.35 |
| 7:59:39 | 1522.54 |
| 8:00:15 | 1518.14 |
| 8:00:51 | 1513.85 |
| 8:01:27 | 1514.7 |
| 8:02:03 | 1525.43 |
| 8:02:39 | 1533.79 |
| 8:03:15 | 1543.44 |
| 8:03:51 | 1549.9 |
| 8:04:27 | 1548.61 |
| 8:05:03 | 1547.15 |
| 8:05:39 | 1545.95 |
| 8:06:15 | 1543.43 |
| 8:06:51 | 1539.92 |
| 8:07:26 | 1536.66 |
| 8:08:02 | 1531.5 |
| 8:08:38 | 1525.81 |
| 8:09:14 | 1519.66 |
| 8:09:50 | 1513.08 |
| 8:10:26 | 1512.24 |
| 8:11:02 | 1515.62 |
| 8:11:38 | 1530.43 |
| 8:12:14 | 1546.59 |
| 8:12:50 | 1547.2 |
| 8:13:26 | 1546.7 |
| 8:14:02 | 1545.82 |
| 8:14:38 | 1543.18 |
| 8:15:14 | 1541.39 |
| 8:15:50 | 1536.15 |
| 8:16:26 | 1532.97 |
| 8:17:02 | 1530.05 |
| 8:17:38 | 1523.18 |
| 8:18:14 | 1520.75 |
| 8:18:50 | 1514.17 |
| 8:19:26 | 1523.2 |
| 8:20:02 | 1533.14 |
| 8:20:38 | 1532.79 |
| 8:21:14 | 1528.03 |
| 8:21:50 | 1521.08 |
| 8:22:25 | 1522.11 |
| 8:23:01 | 1520.89 |
| 8:23:37 | 1510.81 |
| 8:24:13 | 1498.6 |
| 8:24:49 | 1486.71 |
| 8:25:25 | 1464.58 |
| 8:26:01 | 1455.65 |
| 8:26:37 | 1446.62 |
| 8:27:13 | 1442.86 |
| 8:27:49 | 1463.41 |
| 8:28:25 | 1488.11 |
| 8:29:01 | 1508.38 |
| 8:29:37 | 1518.74 |
| 8:30:13 | 1529.76 |
| 8:30:49 | 1537.17 |
| 8:31:25 | 1536.6 |
| 8:32:01 | 1533.14 |
| 8:32:37 | 1525.17 |
| 8:33:13 | 1524.33 |
| 8:33:49 | 1522.95 |
| 8:34:25 | 1521.1 |
| 8:35:01 | 1519.82 |
| 8:35:37 | 1518.87 |
| 8:36:13 | 1517.45 |
| 8:36:49 | 1515.65 |
| 8:37:24 | 1515.39 |
| 8:38:00 | 1518.52 |
| 8:38:36 | 1528.5 |
| 8:39:12 | 1541.7 |
| 8:39:48 | 1540.91 |
| 8:40:24 | 1540.16 |
| 8:41:00 | 1537.56 |
| 8:41:36 | 1532.68 |
| 8:42:12 | 1523.01 |
| 8:42:48 | 1514.37 |
| 8:43:24 | 1512.51 |
| 8:44:00 | 1515.4 |
| 8:44:36 | 1528.01 |
| 8:45:12 | 1549.12 |
| 8:45:48 | 1566.6 |
| 8:46:24 | 1591.5 |
| 8:47:00 | 1582.88 |
| 8:47:36 | 1579.59 |
| 8:48:12 | 1572.02 |
| 8:48:48 | 1567 |
| 8:49:24 | 1566.1 |
| 8:50:00 | 1563.72 |
| 8:50:36 | 1559.59 |
| 8:51:12 | 1559.19 |
| 8:51:48 | 1553.49 |
| 8:52:23 | 1549.28 |
| 8:52:59 | 1543.38 |
| 8:53:35 | 1538.93 |
| 8:54:11 | 1531.98 |
| 8:54:47 | 1527.54 |
| 8:55:23 | 1520.06 |
| 8:55:59 | 1518.66 |
| 8:56:35 | 1512 |
| 8:57:11 | 1510.46 |
| 8:57:47 | 1516.8 |
| 8:58:23 | 1538.85 |
| 8:58:59 | 1556.67 |
| 8:59:35 | 1566.7 |
| 9:00:11 | 1560.83 |
| 9:00:47 | 1555.12 |
| 9:01:23 | 1553.18 |
| 9:01:59 | 1549.47 |
| 9:02:35 | 1549.32 |
| 9:03:11 | 1550.1 |
| 9:03:47 | 1551.14 |
| 9:04:23 | 1552.42 |
| 9:04:59 | 1550.17 |
| 9:05:35 | 1541.97 |
| 9:06:11 | 1539.53 |
| 9:06:47 | 1534.76 |
| 9:07:22 | 1532.91 |
| 9:07:58 | 1525.5 |
| 9:08:34 | 1520.57 |
| 9:09:10 | 1518.59 |
| 9:09:46 | 1512.5 |
| 9:10:22 | 1510.54 |
| 9:10:58 | 1509.42 |
| 9:11:34 | 1511.09 |
| 9:12:10 | 1528.41 |
| 9:12:46 | 1533.87 |
| 9:13:22 | 1566.18 |
| 9:13:58 | 1591.25 |
| 9:14:34 | 1573.89 |
| 9:15:10 | 1572.24 |
| 9:15:46 | 1570.41 |
| 9:16:22 | 1562.4 |
| 9:16:58 | 1561.26 |
| 9:17:34 | 1560.41 |
| 9:18:10 | 1559.66 |
| 9:18:46 | 1558.07 |
| 9:19:22 | 1548.05 |
| 9:19:58 | 1542.21 |
| 9:20:34 | 1538.82 |
| 9:21:10 | 1531.64 |
| 9:21:46 | 1524.34 |
| 9:22:21 | 1521.97 |
| 9:22:57 | 1515.61 |
| 9:23:33 | 1509.27 |
| 9:24:09 | 1508.49 |
| 9:24:45 | 1517.54 |
| 9:25:21 | 1535.31 |
| 9:25:57 | 1546.61 |
| 9:26:33 | 1554.74 |
| 9:27:09 | 1562.12 |
| 9:27:45 | 1564.06 |
| 9:28:21 | 1574.38 |
| 9:28:57 | 1574.84 |
| 9:29:33 | 1566.97 |
| 9:30:09 | 1566.28 |
| 9:30:45 | 1561.85 |
| 9:31:21 | 1558.69 |
| 9:31:57 | 1549.33 |
| 9:32:33 | 1546.23 |
| 9:33:09 | 1539.1 |
| 9:33:45 | 1533.81 |
| 9:34:21 | 1525.34 |
| 9:34:57 | 1516.18 |
| 9:35:33 | 1507.14 |
| 9:36:09 | 1505.81 |
| 9:36:45 | 1518.01 |
| 9:37:20 | 1531.86 |
| 9:37:56 | 1554.32 |
| 9:38:32 | 1563.99 |
| 9:39:08 | 1576.83 |
| 9:39:44 | 1590 |
| 9:40:20 | 1583.98 |
| 9:40:56 | 1583.16 |
| 9:41:32 | 1579.93 |
| 9:42:08 | 1577.61 |
| 9:42:44 | 1578.47 |
| 9:43:20 | 1578.01 |
| 9:43:56 | 1573.13 |
| 9:44:32 | 1567.29 |
| 9:45:08 | 1564.71 |
| 9:45:44 | 1560.32 |
| 9:46:20 | 1554.06 |
| 9:46:56 | 1545.22 |
| 9:47:32 | 1536.95 |
| 9:48:08 | 1531.57 |
| 9:48:44 | 1520.58 |
| 9:49:20 | 1514.83 |
| 9:49:56 | 1514.19 |
| 9:50:32 | 1526.09 |
| 9:51:08 | 1541.41 |
| 9:51:44 | 1544.95 |
| 9:52:19 | 1544.7 |
| 9:52:55 | 1543.15 |
| 9:53:31 | 1536.54 |
| 9:54:07 | 1532.97 |
| 9:54:43 | 1522.12 |
| 9:55:19 | 1501 |
| 9:55:55 | 1504.86 |
| 9:56:31 | 1515.49 |
| 9:57:07 | 1554.31 |
| 9:57:43 | 1594.72 |
| 9:58:19 | 1581.69 |
| 9:58:55 | 1578.96 |
| 9:59:31 | 1577.34 |
| 10:00:07 | 1571.28 |
| 10:00:43 | 1570.39 |
| 10:01:19 | 1569.2 |
| 10:01:55 | 1569.02 |
| 10:02:31 | 1568.81 |
| 10:03:07 | 1564.34 |
| 10:03:43 | 1557.1 |
| 10:04:19 | 1551.67 |
| 10:04:55 | 1547.28 |
| 10:05:31 | 1531.81 |
| 10:06:07 | 1530.39 |
| 10:06:43 | 1519.56 |
| 10:07:18 | 1514.21 |
| 10:07:54 | 1512.76 |
| 10:08:30 | 1519.42 |
| 10:09:06 | 1530.69 |
| 10:09:42 | 1544.09 |
| 10:10:18 | 1550.81 |
| 10:10:54 | 1550.33 |
| 10:11:30 | 1548.65 |
| 10:12:06 | 1542.8 |
| 10:12:42 | 1541.02 |
| 10:13:18 | 1537.74 |
| 10:13:54 | 1530.19 |
| 10:14:30 | 1528.48 |
| 10:15:06 | 1528.96 |
| 10:15:42 | 1529.01 |
| 10:16:18 | 1529.75 |
| 10:16:54 | 1530.13 |
| 10:17:30 | 1526.86 |
| 10:18:06 | 1521.66 |
| 10:18:42 | 1512.05 |
| 10:19:18 | 1510.26 |
| 10:19:54 | 1516.46 |
| 10:20:30 | 1529.82 |
| 10:21:06 | 1548.4 |
| 10:21:42 | 1561.94 |
| 10:22:17 | 1572.51 |
| 10:22:53 | 1569.01 |
| 10:23:29 | 1563.45 |
| 10:24:05 | 1562.52 |
| 10:24:41 | 1562.84 |
| 10:25:17 | 1564.35 |
| 10:25:53 | 1563.21 |
| 10:26:29 | 1561.2 |
| 10:27:05 | 1557.38 |
| 10:27:41 | 1554.12 |
| 10:28:17 | 1548.84 |
| 10:28:53 | 1545.58 |
| 10:29:29 | 1541.8 |
| 10:30:05 | 1539.85 |
| 10:30:41 | 1532.89 |
| 10:31:17 | 1526.82 |
| 10:31:53 | 1521.66 |
| 10:32:29 | 1519.89 |
| 10:33:05 | 1517.12 |
| 10:33:41 | 1508.57 |
| 10:34:17 | 1502.52 |
| 10:34:53 | 1510.72 |
| 10:35:29 | 1529.87 |
| 10:36:05 | 1554.8 |
| 10:36:41 | 1568.52 |
| 10:37:16 | 1570 |
| 10:37:52 | 1569.09 |
| 10:38:28 | 1567.52 |
| 10:39:04 | 1567.26 |
| 10:39:40 | 1576.85 |
| 10:40:16 | 1581.32 |
| 10:40:52 | 1578.59 |
| 10:41:28 | 1570.35 |
| 10:42:04 | 1568.94 |
| 10:42:40 | 1567.89 |
| 10:43:16 | 1563.15 |
| 10:43:52 | 1561.13 |
| 10:44:28 | 1557.47 |
| 10:45:04 | 1555.12 |
| 10:45:40 | 1548.41 |
| 10:46:16 | 1540.41 |
| 10:46:52 | 1536.24 |
| 10:47:28 | 1524.24 |
| 10:48:04 | 1514.32 |
| 10:48:40 | 1513.28 |
| 10:49:16 | 1513.98 |
| 10:49:52 | 1531.54 |
| 10:50:28 | 1555.78 |
| 10:51:04 | 1563.7 |
| 10:51:40 | 1581.18 |
| 10:52:15 | 1590.08 |
| 10:52:51 | 1575.13 |
| 10:53:27 | 1573.64 |
| 10:54:03 | 1571.91 |
| 10:54:39 | 1569.33 |
| 10:55:15 | 1565.4 |
| 10:55:51 | 1565.82 |
| 10:56:27 | 1564.85 |
| 10:57:03 | 1563.39 |
| 10:57:39 | 1552.9 |
| 10:58:15 | 1544.92 |
| 10:58:51 | 1539.92 |
| 10:59:27 | 1533.3 |
| 11:00:03 | 1527.51 |
| 11:00:39 | 1526.38 |
| 11:01:15 | 1521.48 |
| 11:01:51 | 1518.69 |
| 11:02:27 | 1508.63 |
| 11:03:03 | 1508.76 |
| 11:03:39 | 1510.07 |
| 11:04:15 | 1521.7 |
| 11:04:51 | 1534.43 |
| 11:05:27 | 1560.22 |
| 11:06:03 | 1570.76 |
| 11:06:39 | 1581.18 |
| 11:07:14 | 1575.61 |
| 11:07:50 | 1571.99 |
| 11:08:26 | 1570.68 |
| 11:09:02 | 1570.05 |
| 11:09:38 | 1567.74 |
| 11:10:14 | 1567.49 |
| 11:10:50 | 1566.11 |
| 11:11:26 | 1564.54 |
| 11:12:02 | 1561.24 |
| 11:12:38 | 1556.06 |
| 11:13:14 | 1549.86 |
| 11:13:50 | 1548.67 |
| 11:14:26 | 1533.39 |
| 11:15:02 | 1532.13 |
| 11:15:38 | 1527.21 |
| 11:16:14 | 1520.99 |
| 11:16:50 | 1514.18 |
| 11:17:26 | 1510 |
| 11:18:02 | 1510.96 |
| 11:18:38 | 1526.43 |
| 11:19:14 | 1548.92 |
| 11:19:50 | 1559.01 |
| 11:20:26 | 1559.8 |
| 11:21:02 | 1559.88 |
| 11:21:38 | 1557.63 |
| 11:22:13 | 1546.76 |
| 11:22:49 | 1522.9 |
| 11:23:25 | 1513.58 |
| 11:24:01 | 1501.81 |
| 11:24:37 | 1491.13 |
| 11:25:13 | 1511.48 |
| 11:25:49 | 1525.25 |
| 11:26:25 | 1547.59 |
| 11:27:01 | 1587.49 |
| 11:27:37 | 1615.3 |
| 11:28:13 | 1622.86 |
| 11:28:49 | 1623.28 |
| 11:29:25 | 1629.42 |
| 11:30:01 | 1627.97 |
| 11:30:37 | 1627.81 |
| 11:31:13 | 1610.47 |
| 11:31:49 | 1588.57 |
| 11:32:25 | 1580.53 |
| 11:33:01 | 1569.3 |
| 11:33:37 | 1561.99 |
| 11:34:13 | 1556.57 |
| 11:34:49 | 1546.36 |
| 11:35:25 | 1539.22 |
| 11:36:01 | 1532.02 |
| 11:36:37 | 1517.79 |
| 11:37:12 | 1504.21 |
| 11:37:48 | 1502.88 |
| 11:38:24 | 1508.15 |
| 11:39:00 | 1534.92 |
| 11:39:36 | 1542.27 |
| 11:40:12 | 1560.12 |
| 11:40:48 | 1561.58 |
| 11:41:24 | 1569.31 |
| 11:42:00 | 1602.57 |
| 11:42:36 | 1630.03 |
| 11:43:12 | 1623.15 |
| 11:43:48 | 1614.47 |
| 11:44:24 | 1611.08 |
| 11:45:00 | 1610.18 |
| 11:45:36 | 1608.51 |
| 11:46:12 | 1607.48 |
| 11:46:48 | 1598.75 |
| 11:47:24 | 1591.39 |
| 11:48:00 | 1585.69 |
| 11:48:36 | 1580.62 |
| 11:49:12 | 1576.74 |
| 11:49:48 | 1571.49 |
| 11:50:24 | 1565.49 |
| 11:51:00 | 1557.92 |
| 11:51:36 | 1549.07 |
| 11:52:11 | 1542.65 |
| 11:52:47 | 1540.23 |
| 11:53:23 | 1531.1 |
| 11:53:59 | 1529.78 |
| 11:54:35 | 1520.32 |
| 11:55:11 | 1517.97 |
| 11:55:47 | 1513.61 |
| 11:56:23 | 1513.7 |
| 11:56:59 | 1515.11 |
| 11:57:35 | 1533.13 |
| 11:58:11 | 1550.87 |
| 11:58:47 | 1564.56 |
| 11:59:23 | 1587.36 |
| 11:59:59 | 1588.18 |
| 12:00:35 | 1581.23 |
| 12:01:11 | 1580.27 |
| 12:01:47 | 1578.79 |
| 12:02:23 | 1573.9 |
| 12:02:59 | 1567.59 |
| 12:03:35 | 1567.47 |
| 12:04:11 | 1567.51 |
| 12:04:47 | 1565.16 |
| 12:05:23 | 1554.35 |
| 12:05:59 | 1551.26 |
| 12:06:35 | 1544.48 |
| 12:07:10 | 1540.49 |
| 12:07:46 | 1528.76 |
| 12:08:22 | 1523.15 |
| 12:08:58 | 1520.7 |
| 12:09:34 | 1517.39 |
| 12:10:10 | 1510.07 |
| 12:10:46 | 1516.29 |
| 12:11:22 | 1531.6 |
| 12:11:58 | 1548.3 |
| 12:12:34 | 1552.85 |
| 12:13:10 | 1554.14 |
| 12:13:46 | 1554.02 |
| 12:14:22 | 1550.23 |
| 12:14:58 | 1542.21 |
| 12:15:34 | 1540.48 |
| 12:16:10 | 1533.69 |
| 12:16:46 | 1528.04 |
| 12:17:22 | 1507.88 |
| 12:17:58 | 1533.74 |
| 12:18:34 | 1544.35 |
| 12:19:10 | 1545.04 |
| 12:19:46 | 1542.53 |
| 12:20:22 | 1538.79 |
| 12:20:58 | 1539.43 |
| 12:21:34 | 1537.63 |
| 12:22:09 | 1533.7 |
| 12:22:45 | 1526.92 |
| 12:23:21 | 1522.59 |
| 12:23:57 | 1519.81 |
| 12:24:33 | 1516.35 |
| 12:25:09 | 1509.23 |
| 12:25:45 | 1508.19 |
| 12:26:21 | 1520.57 |
| 12:26:57 | 1552.97 |
| 12:27:33 | 1568.78 |
| 12:28:09 | 1582.35 |
| 12:28:45 | 1574.04 |
| 12:29:21 | 1574.23 |
| 12:29:57 | 1571.59 |
| 12:30:33 | 1570.09 |
| 12:31:09 | 1553.8 |
| 12:31:45 | 1548.23 |
| 12:32:21 | 1548.2 |
| 12:32:57 | 1548.62 |
| 12:33:33 | 1547.59 |
| 12:34:09 | 1544.93 |
| 12:34:45 | 1538.97 |
| 12:35:21 | 1536.45 |
| 12:35:57 | 1530.41 |
| 12:36:33 | 1528.81 |
| 12:37:08 | 1525.79 |
| 12:37:44 | 1524.42 |
| 12:38:20 | 1512.65 |
| 12:38:56 | 1513.54 |
| 12:39:32 | 1525.07 |
| 12:40:08 | 1541.86 |
| 12:40:44 | 1563.75 |
| 12:41:20 | 1569.69 |
| 12:41:56 | 1569.45 |
| 12:42:32 | 1568.11 |
| 12:43:08 | 1561.01 |
| 12:43:44 | 1555.42 |
| 12:44:20 | 1551.74 |
| 12:44:56 | 1544.76 |
| 12:45:32 | 1540.13 |
| 12:46:08 | 1538.53 |
| 12:46:44 | 1529.59 |
| 12:47:20 | 1523.21 |
| 12:47:56 | 1519.08 |
| 12:48:32 | 1514.1 |
| 12:49:08 | 1513.1 |
| 12:49:44 | 1502.05 |
| 12:50:20 | 1526.46 |
| 12:50:56 | 1586.25 |
| 12:51:32 | 1620.56 |
| 12:52:07 | 1614 |
| 12:52:43 | 1601.39 |
| 12:53:19 | 1601.76 |
| 12:53:55 | 1603.86 |
| 12:54:31 | 1602.71 |
| 12:55:07 | 1601.32 |
| 12:55:43 | 1593.09 |
| 12:56:19 | 1585.93 |
| 12:56:55 | 1579.51 |
| 12:57:31 | 1574.21 |
| 12:58:07 | 1566.15 |
| 12:58:43 | 1556.04 |
| 12:59:19 | 1554.77 |
| 12:59:55 | 1553.03 |
| 13:00:31 | 1545.92 |
| 13:01:07 | 1539.03 |
| 13:01:43 | 1532.93 |
| 13:02:19 | 1531.59 |
| 13:02:55 | 1529.45 |
| 13:03:31 | 1522.97 |
| 13:04:07 | 1517.31 |
| 13:04:43 | 1514.11 |
| 13:05:19 | 1514.84 |
| 13:05:55 | 1520.18 |
| 13:06:31 | 1527.69 |
| 13:07:06 | 1538.51 |
| 13:07:42 | 1551.43 |
| 13:08:18 | 1568.34 |
| 13:08:54 | 1576.6 |
| 13:09:30 | 1567.74 |
| 13:10:06 | 1565.52 |
| 13:10:42 | 1563.96 |
| 13:11:18 | 1554.28 |
| 13:11:54 | 1553.32 |
| 13:12:30 | 1552.24 |
| 13:13:06 | 1545.65 |
| 13:13:42 | 1538.04 |
| 13:14:18 | 1531.52 |
| 13:14:54 | 1526.32 |
| 13:15:30 | 1516.27 |
| 13:16:06 | 1513.4 |
| 13:16:42 | 1514.22 |
| 13:17:18 | 1524.64 |
| 13:17:54 | 1541.47 |
| 13:18:30 | 1558.07 |
| 13:19:06 | 1560.21 |
| 13:19:42 | 1559.52 |
| 13:20:18 | 1558.59 |
| 13:20:54 | 1557.39 |
| 13:21:30 | 1556.18 |
| 13:22:05 | 1555.23 |
| 13:22:41 | 1551.83 |
| 13:23:17 | 1540.64 |
| 13:23:53 | 1540.09 |
| 13:24:29 | 1538.82 |
| 13:25:05 | 1533.68 |
| 13:25:41 | 1526.91 |
| 13:26:17 | 1521.88 |
| 13:26:53 | 1513.14 |
| 13:27:29 | 1508.49 |
| 13:28:05 | 1514.39 |
| 13:28:41 | 1523.07 |
| 13:29:17 | 1546.83 |
| 13:29:53 | 1556.79 |
| 13:30:29 | 1567.5 |
| 13:31:05 | 1570.72 |
| 13:31:41 | 1559.43 |
| 13:32:17 | 1558.85 |
| 13:32:53 | 1558.8 |
| 13:33:29 | 1557.27 |
| 13:34:05 | 1555.6 |
| 13:34:41 | 1553.93 |
| 13:35:17 | 1551.62 |
| 13:35:53 | 1541.33 |
| 13:36:29 | 1539.14 |
| 13:37:04 | 1531.42 |
| 13:37:40 | 1527.56 |
| 13:38:16 | 1523.44 |
| 13:38:52 | 1514.91 |
| 13:39:28 | 1512.32 |
| 13:40:04 | 1513.59 |
| 13:40:40 | 1528.29 |
| 13:41:16 | 1547.55 |
| 13:41:52 | 1554.59 |
| 13:42:28 | 1556.7 |
| 13:43:04 | 1555.7 |
| 13:43:40 | 1555.02 |
| 13:44:16 | 1553.05 |
| 13:44:52 | 1544.86 |
| 13:45:28 | 1535.24 |
| 13:46:04 | 1534.7 |
| 13:46:40 | 1527.93 |
| 13:47:16 | 1526.32 |
| 13:47:52 | 1526.17 |
| 13:48:28 | 1521.69 |
| 13:49:04 | 1512.85 |
| 13:49:40 | 1511.38 |
| 13:50:16 | 1515.48 |
| 13:50:52 | 1541.15 |
| 13:51:28 | 1559.98 |
| 13:52:03 | 1564.4 |
| 13:52:39 | 1565.1 |
| 13:53:15 | 1564.1 |
| 13:53:51 | 1549.58 |
| 13:54:27 | 1538.78 |
| 13:55:03 | 1542.46 |
| 13:55:39 | 1530.63 |
| 13:56:15 | 1528.54 |
| 13:56:51 | 1529.15 |
| 13:57:27 | 1526.71 |
| 13:58:03 | 1517.29 |
| 13:58:39 | 1515.54 |
| 13:59:15 | 1513.46 |
| 13:59:51 | 1520.17 |
| 14:00:27 | 1538.61 |
| 14:01:03 | 1554.4 |
| 14:01:39 | 1554.12 |
| 14:02:15 | 1554.73 |
| 14:02:51 | 1555.26 |
| 14:03:27 | 1549.32 |
| 14:04:03 | 1542.55 |
| 14:04:39 | 1540.98 |
| 14:05:15 | 1539.91 |
| 14:05:51 | 1539.78 |
| 14:06:27 | 1538.13 |
| 14:07:02 | 1529.42 |
| 14:07:38 | 1524.8 |
| 14:08:14 | 1515.33 |
| 14:08:50 | 1514.53 |
| 14:09:26 | 1518.01 |
| 14:10:02 | 1535.99 |
| 14:10:38 | 1550.72 |
| 14:11:14 | 1550.79 |
| 14:11:50 | 1545.1 |
| 14:12:26 | 1535.62 |
| 14:13:02 | 1529.48 |
| 14:13:38 | 1525.68 |
| 14:14:14 | 1514.88 |
| 14:14:50 | 1513.7 |
| 14:15:26 | 1515.88 |
| 14:16:02 | 1528.14 |
| 14:16:38 | 1561.81 |
| 14:17:14 | 1568.32 |
| 14:17:50 | 1557.94 |
| 14:18:26 | 1558.18 |
| 14:19:02 | 1555.92 |
| 14:19:38 | 1556.49 |
| 14:20:14 | 1556.02 |
| 14:20:50 | 1555.68 |
| 14:21:26 | 1550.04 |
| 14:22:01 | 1543.23 |
| 14:22:37 | 1537.92 |
| 14:23:13 | 1528.89 |
| 14:23:49 | 1525.98 |
| 14:24:25 | 1519.11 |
| 14:25:01 | 1515.97 |
| 14:25:37 | 1512.44 |
| 14:26:13 | 1511.67 |
| 14:26:49 | 1516.37 |
| 14:27:25 | 1531.43 |
| 14:28:01 | 1547.17 |
| 14:28:37 | 1562.37 |
| 14:29:13 | 1569.31 |
| 14:29:49 | 1573.25 |
| 14:30:25 | 1572.26 |
| 14:31:01 | 1570.36 |
| 14:31:37 | 1564.07 |
| 14:32:13 | 1557.66 |
| 14:32:49 | 1557.39 |
| 14:33:25 | 1557.44 |
| 14:34:01 | 1557.17 |
| 14:34:37 | 1556.64 |
| 14:35:13 | 1555.3 |
| 14:35:49 | 1551.1 |
| 14:36:25 | 1543.87 |
| 14:37:00 | 1529.51 |
| 14:37:36 | 1526.11 |
| 14:38:12 | 1521.3 |
| 14:38:48 | 1514.25 |
| 14:39:24 | 1512.46 |
| 14:40:00 | 1509.48 |
| 14:40:36 | 1512.16 |
| 14:41:12 | 1521.87 |
| 14:41:48 | 1557 |
| 14:42:24 | 1605.18 |
| 14:43:00 | 1613.52 |
| 14:43:36 | 1601.23 |
| 14:44:12 | 1597.73 |
| 14:44:48 | 1594.25 |
| 14:45:24 | 1593.59 |
| 14:46:00 | 1585.3 |
| 14:46:36 | 1582.45 |
| 14:47:12 | 1581.75 |
| 14:47:48 | 1574.28 |
| 14:48:24 | 1569.78 |
| 14:49:00 | 1560.16 |
| 14:49:36 | 1552.86 |
| 14:50:12 | 1541.55 |
| 14:50:48 | 1538.76 |
| 14:51:24 | 1530.33 |
| 14:51:59 | 1523.89 |
| 14:52:35 | 1520.8 |
| 14:53:11 | 1515.33 |
| 14:53:47 | 1509.78 |
| 14:54:23 | 1508.79 |
| 14:54:59 | 1516.99 |
| 14:55:35 | 1539.54 |
| 14:56:11 | 1561.1 |
| 14:56:47 | 1570.26 |
| 14:57:23 | 1579.62 |
| 14:57:59 | 1586.85 |
| 14:58:35 | 1587.4 |
| 14:59:11 | 1586 |
| 14:59:47 | 1584.18 |
| 15:00:23 | 1564.69 |
| 15:00:59 | 1542.28 |
| 15:01:35 | 1533.94 |
| 15:02:11 | 1522.08 |
| 15:02:47 | 1520.29 |
| 15:03:23 | 1516.89 |
| 15:03:59 | 1511.1 |
| 15:04:35 | 1504.9 |
| 15:05:11 | 1499.99 |
| 15:05:47 | 1517.2 |
| 15:06:23 | 1521.46 |
| 15:06:58 | 1529.45 |
| 15:07:34 | 1545.4 |
| 15:08:10 | 1576.52 |
| 15:08:46 | 1610.76 |
| 15:09:22 | 1619.6 |
| 15:09:58 | 1635.18 |
| 15:10:34 | 1642.76 |
| 15:11:10 | 1641.49 |
| 15:11:46 | 1640.13 |
| 15:12:22 | 1632.55 |
| 15:12:58 | 1631.12 |
| 15:13:34 | 1629.79 |
| 15:14:10 | 1626.76 |
| 15:14:46 | 1620.1 |
| 15:15:22 | 1612.22 |
| 15:15:58 | 1603.53 |
| 15:16:34 | 1596.14 |
| 15:17:10 | 1586.7 |
| 15:17:46 | 1577.42 |
| 15:18:22 | 1568.21 |
| 15:18:58 | 1563.21 |
| 15:19:34 | 1561.99 |
| 15:20:10 | 1550.79 |
| 15:20:46 | 1543.95 |
| 15:21:22 | 1537.67 |
| 15:21:57 | 1530.23 |
| 15:22:33 | 1521.37 |
| 15:23:09 | 1513.18 |
| 15:23:45 | 1512.23 |
| 15:24:21 | 1519.37 |
| 15:24:57 | 1530.3 |
| 15:25:33 | 1558.55 |
| 15:26:09 | 1569.79 |
| 15:26:45 | 1571.16 |
| 15:27:21 | 1576.17 |
| 15:27:57 | 1575.97 |
| 15:28:33 | 1569.29 |
| 15:29:09 | 1565.26 |
| 15:29:45 | 1557.01 |
| 15:30:21 | 1550.25 |
| 15:30:57 | 1547.64 |
| 15:31:33 | 1546.99 |
| 15:32:09 | 1540.65 |
| 15:32:45 | 1532.65 |
| 15:33:21 | 1526.54 |
| 15:33:57 | 1519.66 |
| 15:34:33 | 1513.74 |
| 15:35:09 | 1516.67 |
| 15:35:45 | 1520.25 |
| 15:36:21 | 1533.79 |
| 15:36:56 | 1548.99 |
| 15:37:32 | 1548.27 |
| 15:38:08 | 1541.54 |
| 15:38:44 | 1536.82 |
| 15:39:20 | 1529.14 |
| 15:39:56 | 1518.88 |
| 15:40:32 | 1512.68 |
| 15:41:08 | 1508.48 |
| 15:41:44 | 1514.94 |
| 15:42:20 | 1551.58 |
| 15:42:56 | 1597.5 |
| 15:43:32 | 1580.9 |
| 15:44:08 | 1577.17 |
| 15:44:44 | 1576.19 |
| 15:45:20 | 1575.9 |
| 15:45:56 | 1574.46 |
| 15:46:32 | 1572.2 |
| 15:47:08 | 1571.52 |
| 15:47:44 | 1570.77 |
| 15:48:20 | 1560.67 |
| 15:48:56 | 1554.55 |
| 15:49:32 | 1549.06 |
| 15:50:08 | 1543.45 |
| 15:50:44 | 1537.69 |
| 15:51:20 | 1531.33 |
| 15:51:55 | 1523.09 |
| 15:52:31 | 1511.24 |
| 15:53:07 | 1513.81 |
| 15:53:43 | 1521.84 |
| 15:54:19 | 1539.68 |
| 15:54:55 | 1557.55 |
| 15:55:31 | 1558.06 |
| 15:56:07 | 1557.15 |
| 15:56:43 | 1555.45 |
| 15:57:19 | 1553.53 |
| 15:57:55 | 1544.92 |
| 15:58:31 | 1531.07 |
| 15:59:07 | 1529.55 |
| 15:59:43 | 1525.89 |
| 16:00:19 | 1517.64 |
| 16:00:55 | 1514.72 |
| 16:01:31 | 1514.73 |
| 16:02:07 | 1515.93 |
| 16:02:43 | 1546.66 |
| 16:03:19 | 1562.99 |
| 16:03:55 | 1554.84 |
| 16:04:31 | 1554.78 |
| 16:05:07 | 1554.41 |
| 16:05:43 | 1554 |
| 16:06:19 | 1551.15 |
| 16:06:54 | 1550.61 |
| 16:07:30 | 1550.99 |
| 16:08:06 | 1549.3 |
| 16:08:42 | 1544.41 |
| 16:09:18 | 1539.01 |
| 16:09:54 | 1531.55 |
| 16:10:30 | 1525.98 |
| 16:11:06 | 1521.31 |
| 16:11:42 | 1513.79 |
| 16:12:18 | 1509.34 |
| 16:12:54 | 1523.44 |
| 16:13:30 | 1539.94 |
| 16:14:06 | 1556.73 |
| 16:14:42 | 1557.62 |
| 16:15:18 | 1554.25 |
| 16:15:54 | 1547.7 |
| 16:16:30 | 1543.48 |
| 16:17:06 | 1530.16 |
| 16:17:42 | 1523.43 |
| 16:18:18 | 1521.88 |
| 16:18:54 | 1520.07 |
| 16:19:30 | 1511.82 |
| 16:20:06 | 1511.38 |
| 16:20:42 | 1516.9 |
| 16:21:18 | 1547.85 |
| 16:21:53 | 1594.85 |

In table 2 set out below, the normalised frequency distribution of the densities given in Table 1 are set out.

The normalised frequency is obtained by multiplying the frequency value by 100 and dividing by the sum of the normalised frequency column. The cumulative normalised frequency is the addition of the particular normalised frequency by the sum of the previous normalised frequencies.

TABLE 2

| Frequency | | | | | |
|---|---|---|---|---|---|
| Distribution | | | | | |
| Density Range | | | | | Cumulative |
| Lower | Upper | Mean | | Normalised | Normalised |
| kg/m3 | kg/m3 | Density | Frequency | Frequency | frequency |
| | 1442 | | 0 | 0.000 | 0.000 |
| 1442 | 1443 | 1442.5 | 1 | 0.111 | 0.111 |
| 1443 | 1444 | 1443.5 | 0 | 0.000 | 0.111 |
| 1444 | 1445 | 1444.5 | 0 | 0.000 | 0.111 |
| 1445 | 1446 | 1445.5 | 0 | 0.000 | 0.111 |
| 1446 | 1447 | 1446.5 | 1 | 0.111 | 0.222 |
| 1447 | 1448 | 1447.5 | 0 | 0.000 | 0.222 |
| 1448 | 1449 | 1448.5 | 0 | 0.000 | 0.222 |
| 1449 | 1450 | 1449.5 | 0 | 0.000 | 0.222 |
| 1450 | 1451 | 1450.5 | 0 | 0.000 | 0.222 |
| 1451 | 1452 | 1451.5 | 0 | 0.000 | 0.222 |
| 1452 | 1453 | 1452.5 | 0 | 0.000 | 0.222 |
| 1453 | 1454 | 1453.5 | 0 | 0.000 | 0.222 |
| 1454 | 1455 | 1454.5 | 0 | 0.000 | 0.222 |
| 1455 | 1456 | 1455.5 | 1 | 0.111 | 0.333 |
| 1456 | 1457 | 1456.5 | 0 | 0.000 | 0.333 |
| 1457 | 1458 | 1457.5 | 0 | 0.000 | 0.333 |
| 1458 | 1459 | 1458.5 | 0 | 0.000 | 0.333 |
| 1459 | 1460 | 1459.5 | 0 | 0.000 | 0.333 |
| 1460 | 1461 | 1460.5 | 0 | 0.000 | 0.333 |
| 1461 | 1462 | 1461.5 | 0 | 0.000 | 0.333 |
| 1462 | 1463 | 1462.5 | 0 | 0.000 | 0.333 |
| 1463 | 1464 | 1463.5 | 1 | 0.111 | 0.443 |
| 1464 | 1465 | 1464.5 | 1 | 0.111 | 0.554 |
| 1465 | 1466 | 1465.5 | 0 | 0.000 | 0.554 |
| 1466 | 1467 | 1466.5 | 0 | 0.000 | 0.554 |
| 1467 | 1468 | 1467.5 | 0 | 0.000 | 0.554 |
| 1468 | 1469 | 1468.5 | 0 | 0.000 | 0.554 |
| 1469 | 1470 | 1469.5 | 0 | 0.000 | 0.554 |
| 1470 | 1471 | 1470.5 | 0 | 0.000 | 0.554 |
| 1471 | 1472 | 1471.5 | 1 | 0.111 | 0.665 |
| 1472 | 1473 | 1472.5 | 0 | 0.000 | 0.665 |
| 1473 | 1474 | 1473.5 | 1 | 0.111 | 0.776 |
| 1474 | 1475 | 1474.5 | 0 | 0.000 | 0.776 |
| 1475 | 1476 | 1475.5 | 0 | 0.000 | 0.776 |
| 1476 | 1477 | 1476.5 | 0 | 0.000 | 0.776 |
| 1477 | 1478 | 1477.5 | 0 | 0.000 | 0.776 |
| 1478 | 1479 | 1478.5 | 0 | 0.000 | 0.776 |
| 1479 | 1480 | 1479.5 | 0 | 0.000 | 0.776 |
| 1480 | 1481 | 1480.5 | 1 | 0.111 | 0.887 |
| 1481 | 1482 | 1481.5 | 0 | 0.000 | 0.887 |
| 1482 | 1483 | 1482.5 | 0 | 0.000 | 0.887 |
| 1483 | 1484 | 1483.5 | 0 | 0.000 | 0.887 |
| 1484 | 1485 | 1484.5 | 0 | 0.000 | 0.887 |
| 1485 | 1486 | 1485.5 | 0 | 0.000 | 0.887 |
| 1486 | 1487 | 1486.5 | 1 | 0.111 | 0.998 |
| 1487 | 1488 | 1487.5 | 0 | 0.000 | 0.998 |
| 1488 | 1489 | 1488.5 | 1 | 0.111 | 1.109 |
| 1489 | 1490 | 1489.5 | 0 | 0.000 | 1.109 |
| 1490 | 1491 | 1490.5 | 1 | 0.111 | 1.220 |
| 1491 | 1492 | 1491.5 | 1 | 0.111 | 1.330 |
| 1492 | 1493 | 1492.5 | 0 | 0.000 | 1.330 |
| 1493 | 1494 | 1493.5 | 0 | 0.000 | 1.330 |
| 1494 | 1495 | 1494.5 | 0 | 0.000 | 1.330 |
| 1495 | 1496 | 1495.5 | 0 | 0.000 | 1.330 |
| 1496 | 1497 | 1496.5 | 0 | 0.000 | 1.330 |
| 1497 | 1498 | 1497.5 | 0 | 0.000 | 1.330 |
| 1498 | 1499 | 1498.5 | 1 | 0.111 | 1.441 |
| 1499 | 1500 | 1499.5 | 1 | 0.111 | 1.552 |
| 1500 | 1501 | 1500.5 | 0 | 0.000 | 1.552 |
| 1501 | 1502 | 1501.5 | 3 | 0.333 | 1.885 |
| 1502 | 1503 | 1502.5 | 3 | 0.333 | 2.217 |
| 1503 | 1504 | 1503.5 | 0 | 0.000 | 2.217 |
| 1504 | 1505 | 1504.5 | 3 | 0.333 | 2.550 |
| 1505 | 1506 | 1505.5 | 1 | 0.111 | 2.661 |
| 1506 | 1507 | 1506.5 | 0 | 0.000 | 2.661 |
| 1507 | 1508 | 1507.5 | 2 | 0.222 | 2.882 |
| 1508 | 1509 | 1508.5 | 11 | 1.220 | 4.102 |
| 1509 | 1510 | 1509.5 | 7 | 0.776 | 4.878 |
| 1510 | 1511 | 1510.5 | 9 | 0.998 | 5.876 |
| 1511 | 1512 | 1511.5 | 9 | 0.998 | 6.874 |
| 1512 | 1513 | 1512.5 | 14 | 1.552 | 8.426 |
| 1513 | 1514 | 1513.5 | 18 | 1.996 | 10.421 |
| 1514 | 1515 | 1514.5 | 20 | 2.217 | 12.639 |
| 1515 | 1516 | 1515.5 | 14 | 1.552 | 14.191 |
| 1516 | 1517 | 1516.5 | 12 | 1.330 | 15.521 |
| 1517 | 1518 | 1517.5 | 10 | 1.109 | 16.630 |
| 1518 | 1519 | 1518.5 | 11 | 1.220 | 17.849 |
| 1519 | 1520 | 1519.5 | 11 | 1.220 | 19.069 |
| 1520 | 1521 | 1520.5 | 15 | 1.663 | 20.732 |
| 1521 | 1522 | 1521.5 | 19 | 2.106 | 22.838 |
| 1522 | 1523 | 1522.5 | 10 | 1.109 | 23.947 |
| 1523 | 1524 | 1523.5 | 12 | 1.330 | 25.277 |
| 1524 | 1525 | 1524.5 | 11 | 1.220 | 26.497 |
| 1525 | 1526 | 1525.5 | 13 | 1.441 | 27.938 |
| 1526 | 1527 | 1526.5 | 17 | 1.885 | 29.823 |
| 1527 | 1528 | 1527.5 | 6 | 0.665 | 30.488 |
| 1528 | 1529 | 1528.5 | 13 | 1.441 | 31.929 |
| 1529 | 1530 | 1529.5 | 15 | 1.663 | 33.592 |
| 1530 | 1531 | 1530.5 | 13 | 1.441 | 35.033 |
| 1531 | 1532 | 1531.5 | 16 | 1.774 | 36.807 |
| 1532 | 1533 | 1532.5 | 11 | 1.220 | 38.027 |
| 1533 | 1534 | 1533.5 | 14 | 1.552 | 39.579 |
| 1534 | 1535 | 1534.5 | 4 | 0.443 | 40.022 |
| 1535 | 1536 | 1535.5 | 5 | 0.554 | 40.576 |
| 1536 | 1537 | 1536.5 | 8 | 0.887 | 41.463 |
| 1537 | 1538 | 1537.5 | 8 | 0.887 | 42.350 |
| 1538 | 1539 | 1538.5 | 13 | 1.441 | 43.792 |
| 1539 | 1540 | 1539.5 | 16 | 1.774 | 45.565 |
| 1540 | 1541 | 1540.5 | 11 | 1.220 | 46.785 |
| 1541 | 1542 | 1541.5 | 13 | 1.441 | 48.226 |
| 1542 | 1543 | 1542.5 | 9 | 0.998 | 49.224 |
| 1543 | 1544 | 1543.5 | 10 | 1.109 | 50.333 |
| 1544 | 1545 | 1544.5 | 13 | 1.441 | 51.774 |
| 1545 | 1546 | 1545.5 | 9 | 0.998 | 52.772 |
| 1546 | 1547 | 1546.5 | 9 | 0.998 | 53.769 |
| 1547 | 1548 | 1547.5 | 10 | 1.109 | 54.878 |
| 1548 | 1549 | 1548.5 | 15 | 1.663 | 56.541 |
| 1549 | 1550 | 1549.5 | 13 | 1.441 | 57.982 |
| 1550 | 1551 | 1550.5 | 14 | 1.552 | 59.534 |
| 1551 | 1552 | 1551.5 | 10 | 1.109 | 60.643 |
| 1552 | 1553 | 1552.5 | 8 | 0.887 | 61.530 |
| 1553 | 1554 | 1553.5 | 8 | 0.887 | 62.417 |
| 1554 | 1555 | 1554.5 | 22 | 2.439 | 64.856 |
| 1555 | 1556 | 1555.5 | 15 | 1.663 | 66.519 |
| 1556 | 1557 | 1556.5 | 11 | 1.220 | 67.738 |
| 1557 | 1558 | 1557.5 | 19 | 2.106 | 69.845 |
| 1558 | 1559 | 1558.5 | 9 | 0.998 | 70.843 |
| 1559 | 1560 | 1559.5 | 9 | 0.998 | 71.840 |
| 1560 | 1561 | 1560.5 | 9 | 0.998 | 72.838 |
| 1561 | 1562 | 1561.5 | 12 | 1.330 | 74.169 |
| 1562 | 1563 | 1562.5 | 7 | 0.776 | 74.945 |
| 1563 | 1564 | 1563.5 | 12 | 1.330 | 76.275 |
| 1564 | 1565 | 1564.5 | 11 | 1.220 | 77.494 |
| 1565 | 1566 | 1565.5 | 9 | 0.998 | 78.492 |
| 1566 | 1567 | 1566.5 | 8 | 0.887 | 79.379 |
| 1567 | 1568 | 1567.5 | 12 | 1.330 | 80.710 |
| 1568 | 1569 | 1568.5 | 10 | 1.109 | 81.818 |
| 1569 | 1570 | 1569.5 | 13 | 1.441 | 83.259 |
| 1570 | 1571 | 1570.5 | 12 | 1.330 | 84.590 |
| 1571 | 1572 | 1571.5 | 9 | 0.998 | 85.588 |
| 1572 | 1573 | 1572.5 | 5 | 0.554 | 86.142 |
| 1573 | 1574 | 1573.5 | 5 | 0.554 | 86.696 |
| 1574 | 1575 | 1574.5 | 7 | 0.776 | 87.472 |
| 1575 | 1576 | 1575.5 | 4 | 0.443 | 87.916 |
| 1576 | 1577 | 1576.5 | 7 | 0.776 | 88.692 |
| 1577 | 1578 | 1577.5 | 5 | 0.554 | 89.246 |
| 1578 | 1579 | 1578.5 | 5 | 0.554 | 89.800 |
| 1579 | 1580 | 1579.5 | 4 | 0.443 | 90.244 |
| 1580 | 1581 | 1580.5 | 5 | 0.554 | 90.798 |
| 1581 | 1582 | 1581.5 | 6 | 0.665 | 91.463 |
| 1582 | 1583 | 1582.5 | 3 | 0.333 | 91.796 |
| 1583 | 1584 | 1583.5 | 2 | 0.222 | 92.018 |
| 1584 | 1585 | 1584.5 | 1 | 0.111 | 92.129 |
| 1585 | 1586 | 1585.5 | 3 | 0.333 | 92.461 |
| 1586 | 1587 | 1586.5 | 4 | 0.443 | 92.905 |
| 1587 | 1588 | 1587.5 | 4 | 0.443 | 93.348 |
| 1588 | 1589 | 1588.5 | 2 | 0.222 | 93.570 |
| 1589 | 1590 | 1589.5 | 0 | 0.000 | 93.570 |
| 1590 | 1591 | 1590.5 | 2 | 0.222 | 93.792 |
| 1591 | 1592 | 1591.5 | 3 | 0.333 | 94.124 |
| 1592 | 1593 | 1592.5 | 0 | 0.000 | 94.124 |
| 1593 | 1594 | 1593.5 | 2 | 0.222 | 94.346 |
| 1594 | 1595 | 1594.5 | 3 | 0.333 | 94.678 |
| 1595 | 1596 | 1595.5 | 1 | 0.111 | 94.789 |
| 1596 | 1597 | 1596.5 | 1 | 0.111 | 94.900 |
| 1597 | 1598 | 1597.5 | 2 | 0.222 | 95.122 |
| 1598 | 1599 | 1598.5 | 1 | 0.111 | 95.233 |
| 1599 | 1600 | 1599.5 | 0 | 0.000 | 95.233 |
| 1600 | 1601 | 1600.5 | 0 | 0.000 | 95.233 |
| 1601 | 1602 | 1601.5 | 4 | 0.443 | 95.676 |
| 1602 | 1603 | 1602.5 | 2 | 0.222 | 95.898 |
| 1603 | 1604 | 1603.5 | 2 | 0.222 | 96.120 |
| 1604 | 1605 | 1604.5 | 0 | 0.000 | 96.120 |
| 1605 | 1606 | 1605.5 | 1 | 0.111 | 96.231 |
| 1606 | 1607 | 1606.5 | 0 | 0.000 | 96.231 |
| 1607 | 1608 | 1607.5 | 1 | 0.111 | 96.341 |
| 1608 | 1609 | 1608.5 | 1 | 0.111 | 96.452 |
| 1609 | 1610 | 1609.5 | 0 | 0.000 | 96.452 |
| 1610 | 1611 | 1610.5 | 3 | 0.333 | 96.785 |
| 1611 | 1612 | 1611.5 | 2 | 0.222 | 97.007 |
| 1612 | 1613 | 1612.5 | 1 | 0.111 | 97.118 |
| 1613 | 1614 | 1613.5 | 1 | 0.111 | 97.228 |
| 1614 | 1615 | 1614.5 | 2 | 0.222 | 97.450 |
| 1615 | 1616 | 1615.5 | 1 | 0.111 | 97.561 |
| 1616 | 1617 | 1616.5 | 0 | 0.000 | 97.561 |
| 1617 | 1618 | 1617.5 | 0 | 0.000 | 97.561 |
| 1618 | 1619 | 1618.5 | 2 | 0.222 | 97.783 |
| 1619 | 1620 | 1619.5 | 1 | 0.111 | 97.894 |
| 1620 | 1621 | 1620.5 | 2 | 0.222 | 98.115 |
| 1621 | 1622 | 1621.5 | 0 | 0.000 | 98.115 |
| 1622 | 1623 | 1622.5 | 3 | 0.333 | 98.448 |
| 1623 | 1624 | 1623.5 | 2 | 0.222 | 98.670 |
| 1624 | 1625 | 1624.5 | 0 | 0.000 | 98.670 |
| 1625 | 1626 | 1625.5 | 0 | 0.000 | 98.670 |
| 1626 | 1627 | 1626.5 | 1 | 0.111 | 98.780 |
| 1627 | 1628 | 1627.5 | 2 | 0.222 | 99.002 |
| 1628 | 1629 | 1628.5 | 0 | 0.000 | 99.002 |
| 1629 | 1630 | 1629.5 | 2 | 0.222 | 99.224 |
| 1630 | 1631 | 1630.5 | 1 | 0.111 | 99.335 |
| 1631 | 1632 | 1631.5 | 1 | 0.111 | 99.446 |
| 1632 | 1633 | 1632.5 | 1 | 0.111 | 99.557 |
| 1633 | 1634 | 1633.5 | 0 | 0.000 | 99.557 |
| 1634 | 1635 | 1634.5 | 0 | 0.000 | 99.557 |
| 1635 | 1636 | 1635.5 | 1 | 0.111 | 99.667 |
| 1636 | 1637 | 1636.5 | 0 | 0.000 | 99.667 |
| 1637 | 1638 | 1637.5 | 0 | 0.000 | 99.667 |
| 1638 | 1639 | 1638.5 | 0 | 0.000 | 99.667 |
| 1639 | 1640 | 1639.5 | 0 | 0.000 | 99.667 |
| 1640 | 1641 | 1640.5 | 1 | 0.111 | 99.778 |
| 1641 | 1642 | 1641.5 | 1 | 0.111 | 99.889 |
| 1642 | 1643 | 1642.5 | 1 | 0.111 | 100.000 |
| 1643 | 1644 | 1643.5 | 0 | 0.000 | 100.000 |
| 1644 | 1645 | 1644.5 | 0 | 0.000 | 100.000 |
| 1645 | | | | | |
| | | | Total = 902 | Total = | |
| | | | | 100.000 | |

The processor 50 then lines up the measured density values from lowest to highest so that the frequency of each measured value can be determined.

A chart is then prepared whereby the mid point of each density range is plotted against the density to give the partition coefficient curve.

The processor 50 then determines an induced value, which in the preferred embodiment uses the density measurements, is a medium induced Ep value from the cumulative frequency distribution of the length of time spent at each density by taking the absolute value of the difference in density at the 75^{th} and 25^{th} percentiles and dividing by 2000 as shown by the following equation:
Ep=absolute value (Density at 75^{th} percentile−Density at 25^{th} percentile)/2000 Equation

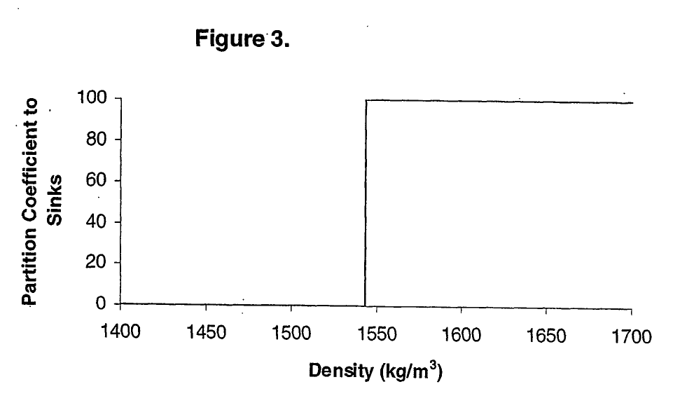

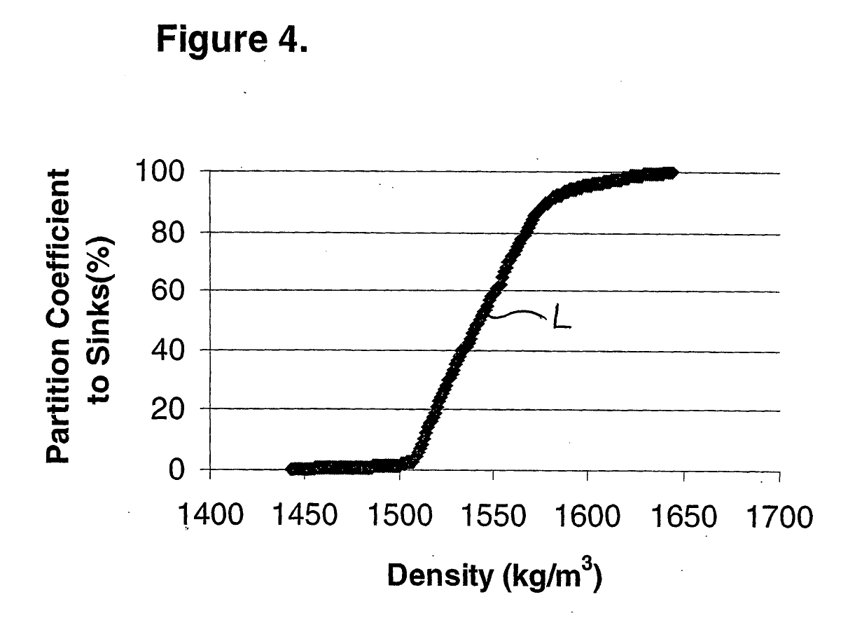

By way of further explanation, the inefficiency of the processing is generally given by the Ep value. FIG. 3 is a graph in an ideal situation where perfect separation results in correct placement of all material in the feed that should report to product reporting to product and all material in feed that should report to reject reporting to reject. If the above equation is applied to the data in FIG. 3, it will be seen that the Ep value is 0, which gives a theoretically perfect result. However, in real operating conditions, the graph of FIG. 3 is more likely to look like that shown in FIG. 4 Using the data. supplied in Table 2 and FIG. 4, the Ep value is (1562.5−1523.5)/2000, which equals 0.0195. The processor 50 is programmed to generate an alarm, should the calculated Ep value become, for example, 0.025. Thus, the graph shown in FIG. 4 is indicative of a acceptable MIEp value in this context indicating that remedial action does not need to be taken. If the value was above 0.025, an alarm condition would be generated. As shown in FIG. 2, the processor may output a signal to an alarm 52 to generate the alarm, which could be an audible alarm or simply a visual indication on a monitor or a combination of both to alert operators in the control room that fluctuations have exceeded a desired value and that remedial action should be taken to correct the situation to restore the proper medium density, and thereby restore maximum yield operation to the processing plant.

The remedial action which may be taken may be to dispatch workmen to inspect valves in the system to ensure that they are operating properly and have not jammed or closed, pipelines to ensure that there are no leakages, and other operating parameters of the equipment. Action can be taken by workmen to correct any fault which may be observed immediately, rather than awaiting routine inspections or the like which may result in a fault continuing for a continued period of time, and thereby resulting in significant loss in the yield from the plant until the remedial action is identified and taken.

The remedial action may also take the form of an automated response, for example the remedial action may be to invoke a control system retune algorithm to optimise PID control system values.

MIEp values are periodically determined after an initial period of 9 hours by simply dropping off the first measurement made and adding to the total of measurements the next successive measurement made. For example, in Table 1, the next MIEp value may be calculated by dropping off the density reading for the time 7:21:54 and adding to the list of density values measured that for time period 16:21:53. This would provide a new MIEP value for comparison with the predetermined value every 36 seconds. Obviously, if a greater period is desired, then additional earlier readings can be ignored and more subsequent measurements made before a further MIEp value is calculated. Also, if measurements of MIEp over a shorter period are desired, density data would be collected for the shorter period and used in a manner similar to that presented above.

An additional example is given with the same data as shown in Table 1 for the situation where measurements of MIEp over a shorter period are required. For a rolling period of 90 minutes a rolling MIEp can be calculated. It is then possible to plot rolling MIEp as ordinate and time as abscissa.

In accordance with the preferred embodiment of the invention, the processing plant can be monitored to determine when its separating performance drops below required levels, thereby enabling remedial action to be immediately taken, and this could be worth millions of dollars per annum to the operation. The monitoring can take the form of a run chart of MIEp in which upper and lower control limits can be derived. Derivation above the upper control limit can be used as the signal for corrective action in the processor 50. Also, the run charts of MIEp can be used as a benchmarking tool to compare control systems within a given plant, and also between plants.

In the second embodiment of the invention in which the pressure measurements are taken so as to produce a pressure induced Ep value, a similar algorithm to that described above is used with the inclusion of a theoretically and/or empirically determined relationship between pressure and separating density. Alternatively, the pseudo PIEp concept can be used. The pressure values are measured at the time intervals similar to that in FIG. 1. The separating density is a function of the pressure and therefore the pressure values can be converted to separating density values via an appropriate empirical or theoretical calibration which are accumulated in the same manner as described with reference to Table 2 so as to enable the Ep value to be calculated.

Similarly, in the embodiment which uses feed rate, the feed rate of material is measured as, for example, weight in tonnes per hour, and these values are again converted to separation density values so that an accumulation of separation densities can be used to enable the feed rate induced Ep value to be determined. Alternatively, the pseudo FRIEP concept can be used.

Similarly, in the embodiment which uses Medium to Coal Ratio, the Medium to Coal Ratio is measured as, for example, cubic meters of medium per hours divided by weight in tonnes per hour of dense medium cyclone feed, and these values are again converted to separation density values so that an accumulation of separation densities can be used to enable the Medium to Coal Ratio induced Ep value to be determined. Alternatively, the pseudo MCRIEP concept can be used.

For the example given above, the detailed calculations presented indicated that the medium induced Ep was 0.0195. Following similar lines, it is possible to calculate a pressure induced Ep=0.002. At the same time, the measured Ep for coal was 0.026. This is interpreted as about 70% of the Ep was due to medium density variation and about 7% was due to pressure variation.

The additional interpretation of the invention is that the large proportion of the actual separating inefficiencies of the dense medium separator is due to process variation and can be measured with relative ease in most modern processing facilities. Also, if the MIEp=0.0195 then the Ep of the coal cannot be smaller than 0.0195, and so the invention also permits the lower limit of coal separating efficiency to be measured with relative ease on-line.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, ie. to specify the presence of the stated features but not to preclude the presence or addition of further features in various embodiments of the invention.

1. A method of processing particulate material, including the steps of:
supplying the particulate material to a separator;
monitoring a parameter of the separator indicative of a separation value of the material;
determining from said parameter an induced value indicative of the separating efficiency of the material that passed through said separator;
comparing said value with a predetermined value; and
generating an alarm condition if the said value departs from the predetermined value by a predetermined amount.

2. The method of claim 1 wherein the separator is a medium dense separator and the separation value comprises the separating density of the separator.

3. The method of claim 1 wherein the separator is a classifying separator and the separation value is the separation size of the material at which separation is to take place.

4. The method of claim 1 wherein the separator comprises a heavy medium device containing a dense medium.

5. The method of claim 1 wherein the step of determining the induced value comprises determining an induced set of values indicative of the separating efficiency of the material that passed through the device, the step of comparing said value comprises comparing said set of values with a predetermined range for the set of values, and the step of generating the alarm condition comprises generating the alarm condition if the said set of values departs from the predetermined range for the set of values by a predetermined amount.

6. The method of claim 5 wherein the set of values is in the form of a partition coefficient curve and parameters derived therefrom.

7. The method of claim 1 wherein the parameter which is monitored is the actual density of the medium.

8. The method of claim 1 wherein the parameter is pressure of the medium and particle mixture which is supplied to the device.

9. The method of claim 1 wherein the parameter is the feed rate of the medium and particle mixture supplied to the device.

10. The method of claim 1 wherein the parameter is the overall processing plant feed rate.

11. The method of claim 1 wherein the parameter is the ratio of volume or mass flow rate of medium to the volume of mass flow rate of the material.

12. The method of claim 1 wherein the parameter is two or more of the medium density, pressure of the medium and particle mixture, feed rate of the medium and particle mixture, and ratio of volume or mass flow rate of medium to the volume of mass flow rate of the material.

13. The method of claim 7 wherein the density of the medium is measured at predetermined time intervals, and for a predetermined time period, the number of measurements at each measured value is determined to produce a cumulative normalised frequency distribution of the length of time the particle spends at each measured density, and said set of values characterising separating efficiency is determined as a medium induced partition coefficient curve and/or a parameter derived therefrom, for example medium induced Ep value (MIEp value) by taking the absolute value of the difference in density at the 75^{th} and 25^{th} percentiles, and dividing by 2000 so as to produce an MIEp value which is a theoretical value solely dependent on medium density variations, and comparing the MIEp value with the said predetermined value, or medium induced partition coefficient curve with a predetermined partition coefficient curve.

14. The method according to claim 8 wherein a pressure induced partition coefficient curve is derived by taking the absolute value of the difference in pressure at the 75^{th} and 25^{th} percentiles, and dividing by 2000 so as to produce a PIEp value which is a theoretical value dependent on pressure variations and comparing the PIEp value with the said predetermined value, or pressure induced partition coefficient curve with a predetermined partition coefficient curve.

15. The method according to claim 14 wherein a pseudo PIEp value is used as the PIEp value to avoid the need for calibration.

16. The method according to claim 10 wherein a feed rate induced partition coefficient curve is derived by taking the absolute value of the difference in feed rate at the 75^{th} and 25^{th} percentiles, and dividing by 2000 so as to produce a FRIEP value which is a theoretical value dependent on feed rate variations and comparing the FRIEp value with the said predetermined value, or feed rate induced partition coefficient curve with a predetermined partition coefficient curve.

17. The method according to claim 16 wherein a pseudo FRIEP value is used as the FRIEP value to avoid the need for calibration.

18. The method according to claim 11 wherein a ratio of medium to material induced partition coefficient curve is derived by taking the absolute value of the difference in ratio at the 75^{th} and 25^{th} percentiles, and dividing by 2000 so as to produce a MCRIEP value which is a theoretical value dependent on ratio variations and comparing the MCRIEP value with the said predetermined value, or ratio induced partition coefficient curve with a predetermined partition coefficient curve.

19. The method according to claim 18 wherein a pseudo MCRIEP value is used as the MCRIEp value to avoid the need for calibration.

20. An apparatus for processing particulate material, comprising:
means for supplying the particulate material to a separator;.
means for monitoring a parameter of the separator indicative of a separation value of the material;
processing means for determining from said parameter an induced value indicative of the separating efficiency of the material that passed through said separator;
comparing means for comparing said value with a predetermined value; and
alarm means for producing an alarm condition if the said value departs from the predetermined value set by a predetermined amount.

21. The apparatus of claim 20 wherein the separator comprises a heavy medium device.

22. The apparatus of claim 20 wherein the processing means is for determining from said parameter an induced set of values indicative of the separating efficiency of the material that passed through the device, the comparing means is for comparing the said value set with a predetermined value set and the alarm means is for producing the alarm condition if the set of values departs from the predetermined value set by a predetermined amount.

23. The apparatus of claim 20 wherein the parameter is density of medium, and the monitoring means is for measuring the density of the medium at predetermined time intervals, and for a predetermined time period, and the processing means is for determining the number of measurements at each measured value to produce a cumulative normalised frequency distribution of the length of time the particle spends at each measured density, and for determining said value set as a medium induced partition coefficient curve and/or parameters derived therefrom by taking the absolute value of the difference in relative density at the 75^{th} and 25^{th} percentiles, and dividing by 2000 so as to produce an MIEP value which is a theoretical value solely dependent on medium density variations, and comparing the partition coefficient curve and parameters derived therefrom with the said predetermined value set.

24. The apparatus according to claim 20 wherein the parameter is feed rate and the processing means is for determining a feed rate induced partition coefficient curve by taking the absolute value of the difference in feed rate at the 75^{th} and 25^{th} percentiles, and dividing by 2000 so as to produce a FRIEP value which is a theoretical value dependent on feed rate variations and comparing the FRIEp value with the said predetermined value, or feed rate induced partition coefficient curve with a predetermined partition coefficient curve.

25. The apparatus according to claim 24 wherein a pseudo FRIEp value is used as the FRIEp value to avoid the need for calibration.

26. The apparatus according to claim 20 wherein the parameter is pressure and the processing means is for determining a pressure induced partition coefficient curve by taking the absolute value of the difference in pressure at the 75^{th} and 25^{th} percentiles, and dividing by 2000 so as to produce a PIEp value which is a theoretical value dependent on pressure variations and comparing the PIEp value with the said predetermined value, or pressure induced partition coefficient curve with a predetermined partition coefficient curve.

27. The apparatus according to claim 26 wherein a pseudo PIEp value is used as the PIEP value to avoid the need for calibration.

28. The apparatus according to claim 20 wherein the parameter is material to medium ratio and the processing means is for determining a ratio induced partition coefficient curve by taking the absolute value of the difference in ratio at the 75^{th} and 25^{th} percentiles, and dividing by 2000 so as to produce a MCRIEp value which is a theoretical value dependent on ratio variations and comparing the MCRIEP value with the said predetermined value, or ratio induced partition coefficient curve with a predetermined partition coefficient curve.

29. The method according to claim 28 wherein a pseudo MCRIEP value is used as the MCRIEP value to avoid the need for calibration.

30. A method of determining the efficiency of separation of particulate material supplied to a separator, comprising the steps of:
monitoring a parameter of the separator indicative of a separation value of the material;
determining from said parameter an induced value indicative of the separating efficiency of the material that pass through the separator; and
using the induced value to provide a measure of the efficiency of separation.

31. The method of claim 30 wherein the step of determining the induced value comprises determining an induced set of values indicative of the separating efficiency of the material that passed through the device, the step of comparing said value comprises comparing said set of values with a predetermined range for the set of values, and the step of generating the alarm condition comprises generating the alarm condition if the said set of values departs from the predetermined range for the set of values by a predetermined amount.

32. The method of claim 31 wherein the set of values may be in the form of a partition coefficient curve and parameters derived therefrom.

33. The method of claim 31 wherein the parameter which is monitored is the actual density of the medium.

34. The method of claim 31 wherein the parameter is pressure of the medium and particle mixture which is supplied to the device.

35. The method of claim 31 wherein the parameter is the feed rate of the medium and particle mixture supplied to the device.

36. The method of claim 31 wherein the parameter is the overall processing plant feed rate.

37. The method of claim 30 wherein the parameter is the ratio of volume or mass flow rate of medium to the volume of mass flow rate of the material.

38. The method of claim 30 wherein the parameter is two or more of the medium density, pressure of the medium and particle mixture, feed rate of the medium and particle mixture, and the ratio of volume or mass flow rate of medium to the volume of mass flow rate of the material.

39. The method of claim 33 wherein the density of the medium is measured at predetermined time intervals, and for a predetermined time period, the number of measurements at each measured value is determined to produce a cumulative normalised frequency distribution of the length of time the particle spends at each measured density, and said set of values characterising separating efficiency is determined as a medium induced partition coefficient curve and/or a parameter derived therefrom, for example medium induced Ep value (MIEp value) by taking the absolute value of the difference in density at the 75^{th} and 25^{th} percentiles, and dividing by 2000 so as to produce an MIEp value which is a theoretical value solely dependent on medium density variations, and comparing the MIEp value with the said predetermined value, or medium induced partition coefficient curve with a predetermined partition coefficient curve.

40. The method according to claim 36 wherein a feed rate induced partition coefficient curve is derived by taking the absolute value of the difference in feed rate at the 75^{th} and 25^{th} percentiles, and dividing by 2000 so as to produce a FRIEP value which is a theoretical value dependent on feed rate variations and comparing the FRIEp value with the said predetermined value, or feed rate induced partition coefficient curve with a predetermined partition coefficient curve.

41. The method according to claim 40 wherein a pseudo FRIEp value is used as the FRIEP value to avoid the need for calibration.

42. The method according to claim 34 wherein a pressure induced partition coefficient curve is derived by taking the absolute value of the difference in pressure at the 75^{th} and 25^{th} percentiles, and dividing by 2000 so as to produce a PIEp value which is a theoretical value dependent on pressure variations and comparing the PIEp value with the said predetermined value, or pressure induced partition coefficient curve with a predetermined partition coefficient curve.

43. The method according to claim 42 wherein a pseudo PIEp value is used as the PIEp value to avoid the need for calibration.

44. The method according to claim 37 wherein a ratio of material to medium induced partition coefficient curve is derived by taking the absolute value of the difference in ratio at the 75^{th} and 25^{th} percentiles, and dividing by 2000 so as to produce a MCRIEP value which is a theoretical value dependent on ratio variations and comparing the MCRIEP value with the said predetermined value, or ratio induced partition coefficient curve with a predetermined partition coefficient curve.

45. The method according to claim 44 wherein a pseudo MCRIEP value is used as the MCRIEP value to avoid the need for calibration.

46. The use of the measure of efficiency determined according to claim 18 to adjust a processing plant to more efficiently separate the material.

47. An apparatus for processing particulate material, comprising:
means for supplying the particulate material to a separator;
means for monitoring a parameter of the separator indicative of a separation value of the material; and
processing means for determining from said parameter an induced value indicative of the separating efficiency of the material that pass through said separator to thereby provide a measure of the efficiency of the apparatus.

48. The apparatus of claim 47 wherein the separator comprises a heavy medium device.

49. The apparatus of claim 47 wherein the processing means is for determining from said parameter an induced set of values indicative of the separating efficiency of the material that passed through the device, the comparing means is for comparing the said value set with a predetermined value set and the alarm means is for producing the alarm condition if the set of values departs from the predetermined value set by a predetermined amount.

50. The apparatus of claim 47 wherein the parameter is the density of the medium, and the monitoring means is for measuring the density of the medium at predetermined time intervals, and for a predetermined time period, and the processing means is for determining the number of measurements at each measured value to produce a cumulative normalised frequency distribution of the length of time the particle spends at each measured density, and for determining said value set as a medium induced partition coefficient curve and/or parameters derived therefrom by taking the absolute value of the difference in relative density at the 75^{th} and 25^{th} percentiles, and dividing by 2000 so as to produce an MIEp value which is a theoretical value solely dependent on medium density variations, and comparing the partition coefficient curve and parameters derived therefrom with the said predetermined value set.

51. The apparatus according to claim 47 wherein the parameter is pressure and the processing means is for determining a pressure induced partition coefficient curve is derived by taking the absolute value of the difference in pressure at the 75^{th} and 25^{th} percentiles, and dividing by 2000 so as to produce a PIEp value which is a theoretical value dependent on pressure variations and comparing the PIEp value with the said predetermined value, or pressure induced partition coefficient curve with a predetermined partition coefficient curve.

52. The method according to claim 51 wherein a pseudo PIEp value is used as the PIEp value to avoid the need for calibration.

53. The method according to claim 47 wherein the parameter is feed rate and the processing means is for determining a feed rate induced partition coefficient curve by taking the absolute value of the difference in feed rate at the 75^{th} and 25^{th} percentiles, and dividing by 2000 so as to produce a FRIEP value which is a theoretical value dependent on feed rate variations and comparing the FRIEp value with the said predetermined value, or feed rate induced partition coefficient curve with a predetermined partition coefficient curve.

54. The method according to claim 53 wherein a pseudo FRIEp value is used as the FRIEP value to avoid the need for calibration.

55. The method according to claim 47 wherein the parameter is ratio of medium to material and the processing means is for determining a ratio induced partition coefficient curve by taking the absolute value of the difference in ratio at the 75^{th} and 25^{th} percentiles, and dividing by 2000 so as to produce a MCRIEp value which is a theoretical value dependent on ratio variations and comparing the MCRIEp value with the said predetermined value, or ratio induced partition coefficient curve with a predetermined partition coefficient curve.

56. The: method according to claim 55 wherein a pseudo MCRIEP value is used as the MCRIEp value to avoid the need for calibration.
